(19) United States
(12) Patent Application Publication
(10) Pub. No.: US 2011/0252091 A1
(43) Pub. Date: Oct. 13, 2011

(54) METHODS AND APPARATUS TO EXCHANGE CONVERGED ADDRESS BOOK EVENTS AMONG MULTIPLE NETWORK DOMAINS

(76) Inventor: Suresh Chitturi, Plano, TX (US)

(21) Appl. No.: 12/903,907

(22) Filed: Oct. 13, 2010

Related U.S. Application Data
(60) Provisional application No. 61/252,045, filed on Oct. 15, 2009.

(51) Int. Cl. G06F 15/16

(52) U.S. Cl. 709/204

(57) ABSTRACT

Methods and apparatus to exchange converged address book events among multiple network domains are disclosed. An example method for a converged address book (CAB) server disclosed herein comprises detecting that a contact corresponding to a second CAB user has been added to an address book of a first CAB user, the address book being managed by the CAB server, and exchanging data between a first domain associated with the first CAB user and a second domain associated with the second CAB user to provide a notification to the second CAB user when the contact corresponding to the second CAB user is added to the address book.

### RELATED APPLICATION

This patent claims priority from U.S. Provisional Application Ser. No. 61/252,045, entitled “Methods and Apparatus to Exchange Converged Address Book Events Among Multiple Network Domains” and filed on Oct. 15, 2009. U.S. Provisional Application Ser. No. 61/252,045 is hereby incorporated by reference in its entirety.

### FIELD OF THE DISCLOSURE

This disclosure relates generally to converged address book services and, more particularly, to methods and apparatus to exchange converged address book events among multiple network domains.

### BACKGROUND

Modern user computing devices provide many applications implementing features that utilize personal contact information obtained from one or more address books. A typical address book contains a list of contact entries, with each contact entry comprising a set of contact information. Such information could include, but is not limited to, a name, a physical address, an email address, a telephone number, a personal identification number, an instant messaging identifier, etc., which enables one user to contact another user. Additionally, an address book system may maintain and manage a computing device user's own personal contact information. The Open Mobile Alliance (OMA) is standardizing a Converged Address Book (CAB) enabler to permit users to manage (e.g., add, modify, delete, etc.), publish, subscribe, import, search and share contact information among various computing devices, users, and applications.

### BRIEF DESCRIPTION OF THE DRAWINGS

FIG. 1 is a block diagram of an example converged address book (CAB) system capable of exchanging events among multiple network domains according to the example methods and apparatus described herein.

FIG. 2 is a block diagram illustrating example implementations of a CAB home domain included in the CAB system of FIG. 1.

FIG. 3 is a block diagram illustrating example implementations of a CAB remote domain included in the CAB system of FIG. 1.

FIG. 4 illustrates an example message sequence diagram illustrating operation of the CAB system of FIG. 1 to exchange events among multiple network domains.

FIG. 5, which comprises FIGS. 5A-D, illustrates an example extensible markup language (XML) schema to use in formatting CAB event information to be exchanged among multiple network domains in the CAB system of FIG. 1.

FIG. 6, which comprises FIGS. 6A-C, illustrates an example XML list fragment for use in exchanging events among multiple network domains in the CAB system of FIG. 1.

FIG. 7 illustrate a flowchart of a generic event write process and a flowchart of a generic event watch process that may be performed to implement one or more of the CAB servers in the examples of FIGS. 1-3.

FIG. 8 illustrates a flowchart representative of an example address book add event write process that may be performed to implement one or more of the CAB servers in the examples of FIGS. 1-3.

FIG. 9 illustrates a flowchart representative of an example address book add event watch process that may be performed to implement one or more of the CAB servers in the examples of FIGS. 1-3.

FIG. 10 illustrates a flowchart representative of an example new CAB user event write process that may be performed to implement one or more of the CAB servers in the examples of FIGS. 1-3.

FIG. 11 illustrates a flowchart representative of an example new CAB user event watch process that may be performed to implement one or more of the CAB servers in the examples of FIGS. 1-3.

FIG. 12 illustrates a flowchart representative of an example contact subscription request write process that may be performed to implement one or more of the CAB servers in the examples of FIGS. 1-3.

FIG. 13 illustrates a flowchart representative of an example contact subscription request event watch process that may be performed to implement one or more of the CAB servers in the examples of FIGS. 1-3.

FIG. 14 is a block diagram of an example computing device that may execute example machine readable instructions to implement any or all of the processes of FIGS. 7-13 to implement any or all of the CAB servers included in the examples of FIGS. 1-3.

### DETAILED DESCRIPTION

Although the following discloses example methods and apparatus including, among other components, software executed on hardware, it should be noted that such methods and apparatus are merely illustrative and should not be considered as limiting. For example, any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

Currently, there are a wide variety of address book systems employing different data formats and communication protocols that are often not interoperable among different computing devices or applications. The Open Mobile Alliance (OMA) is an example of one organization working to define a global standard for interoperable address book management and use. In particular, the OMA is standardizing a converged address book (CAB) enabler to permit users to manage (e.g., add, modify, delete, etc.), publish, subscribe, import, search and share contact information among various computing devices, users and applications. As used herein, and defined by the OMA, the term “enabler,” in general, refers to any system, technology, etc., supporting development, deployment or operation of a service, such as a CAB service. Example CAB services include, but are not limited to, an address book management service to manage (e.g., add, modify, delete, etc.) address book data stored in a network repository, a personal contact card management service to manage a user's own personal contact information stored in the network repository, a search service to allow searching for available contact information internal or external to the CAB system, a contact share service to allow sharing of contact information among users, a contact subscription service to allow a user to subscribe to changes in contact information maintained by other users, and an import non-CAB address book service to allow for the import of legacy address book information (e.g., from non-CAB address book systems).

An OMA-compliant CAB system is required to notify CAB users when one or more CAB-related events occur. For example, based on user preferences and service provider policy, a CAB server (or, more specifically, a CAB service/enabler implemented by the CAB server) is required to notify a first CAB user when a second CAB user adds the first CAB user to the second CAB user's address book contacts. As another example, based on user preferences and service provider policy, the CAB server (or, more specifically, a CAB service/enabler implemented by the CAB server) is required to notify a first CAB user when a non-CAB contact in an address book of the first CAB user becomes a CAB user itself. As yet another example, based on user preferences and service provider policy, the CAB server (or, more specifically, a CAB service/enabler implemented by the CAB server) is required to notify a first CAB user when it is the target of a contact subscription request. Such notification of a contact subscription request enables implementation of reactive authorization in the CAB system or, in other words, can be used to permit the first CAB user to react by selectively allowing or rejecting the contact subscription requests from other CAB users. These and additional notification requirements are specified in OMA's “Converged Address Book Requirements,” Candidate Version 1.0, OMA-RD-CAB-V1_{—}0-20090907-C (Sep. 9, 2009), which is publicly available.

To perform such notification of CAB events, a CAB server may need to convey such event information to CAB users within the CAB server's network domain or to CAB users in other network domains having other CAB servers. If all of the CAB users associated with a particular notification event reside in the same domain as the CAB server (also referred to herein as the home domain of the home CAB server), the home CAB server has complete control over how the event notification is to be processed. However, if a CAB user associated with a notification event resides in another network domain associated with another CAB server (also referred to herein as a remote domain of a remote CAB server), the home CAB server needs to convey the event notification to the remote CAB server which, in turn, will process the event and notify the remote CAB user. The OMA standard specifies various network-to-network interfaces (NNIs) to support CAB server interaction among different network domains. However, the OMA standard does not specify any particular mechanism for exchanging CAB events or CAB event information among multiple network domains.

Accordingly, example methods and apparatus to exchange CAB events among multiple network domains using a network repository are described herein. An example CAB event exchanging technique described herein involves a first CAB server in a first network domain writing first CAB event notification information associated with a first CAB event to a first network repository to exchange the first CAB event notification information with a second CAB server in a second network domain. This example technique also involves the first CAB server monitoring for second CAB event notification information updated in a second network repository by the second CAB server or a third CAB server in a third network domain, with the second CAB event information being associated with a second CAB event. Then, if the second CAB event notification information is detected in the second network repository, the first CAB server determines whether the second CAB event notification information is associated with a first CAB user in the first network domain. If the second CAB event notification information is associated with a first CAB user in the first network domain, the first CAB server processes the second CAB event notification information to notify the first CAB user of the second event. In the preceding example, the terms “first” and “second” are used merely to differentiate between different items and are not meant to indicate any particular relative priority, importance, ordering, etc., of these items. Examples of the CAB events and associated CAB event information that can be exchanged among multiple network domains using the example methods and apparatus described herein include address book contact add events, new CAB user events, contact subscription request events, contact share events, etc., as mentioned above and described in greater detail below.

In an example implementation, each network repository is implemented by an extensible markup language (XML) document management server (XDMS). In such an example, the methods and apparatus described herein implement an XML document management (XDM) application usage specifying the syntax/schema for exchanging event information among CAB servers in different network domains. This example XDM application usage is referred to herein as the CAB NNI events list application usage, which supports exchanging event information for one or more events among two or more CAB servers in two or more different network domains. In such an example, each CAB server maintains its own CAB NNI events list in an XDMS associated with its home domain, which is monitored (and updated, if appropriate) by other remote CAB servers in the remote domains. As such, in addition to maintaining its own CAB NNI events list, each CAB server also monitors (and updates, if appropriate) the CAB NNI events list(s) maintained by the CAB server(s) in the other (remote) domain(s). In this way, multiple CAB NNI events list(s) stored on multiple XDMSs are used to exchange information among multiple CAB servers in multiple network domains. As another example, in a federated environment, the CAB NNI events lists for different CAB servers may be maintained in a single logical entity (e.g., in a central XDMS). In at least some example implementations, such an arrangement enables simplified management of CAB events occurring in different domains.

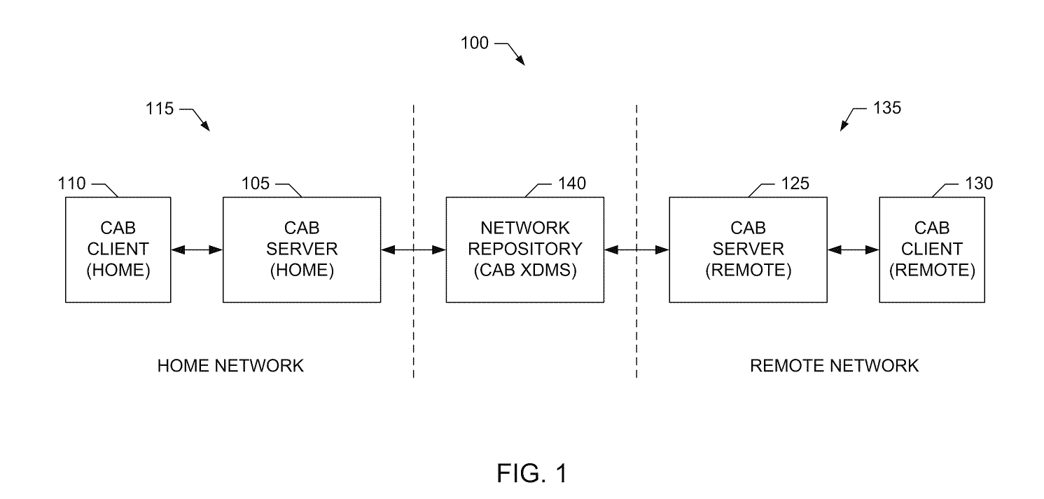

Turning to the figures, an example CAB system 100 capable of using a network repository to exchange CAB event notifications among multiple network domains is shown in FIG. 1. The CAB system 100 includes a first CAB server 105 and a first CAB client 110 operating in a first network domain 115. The CAB system 100 also includes a second CAB server 125 and a second CAB client 130 operating in a second network domain 135. The CAB servers 105 and 125 are also in communication with a network repository 140 storing CAB contact information, such as address book information, personal contact information, etc. As described in greater detail below, the CAB servers 105, 125 and the network repository 140 implement the methods and apparatus described herein to exchange CAB event information among multiple network domains.

For ease of discussion, operation of the CAB system 100 is described from the perspective of the first CAB server 105 being a home CAB server 105 and the first network domain 115 being its home domain 115, whereas the CAB server 125 is a remote CAB server 125 and the second network domain 135 is a remote domain 135. However, it is readily apparent that each CAB server 105, 125 considers itself to be operating in its own home domain, and treats the other CAB server 105, 125 as operating in a remote domain. In other words, from the perspective of the CAB server 125, the second domain 135 is its home domain and the first network domain 115 is a remote domain.

In the illustrated example of FIG. 1, each example CAB client 110 and 130 can be implemented in a respective user computing device to provide CAB functionality to applications operating on the user device. Examples of user devices that can implement the CAB clients 110 and 115 include, but are not limited to, mobile communication devices, mobile computing devices, or any other device capable of accessing information over a wired or wireless network, such as mobile smart phones (e.g., a BLACKBERRY® smart phone), personal digital assistants (PDA), laptop/notebook/netbook computers, desktop computers, set-top boxes, network entities acting on behalf of the user, etc.

Each CAB server 105, 125 in the illustrated example of FIG. 1 implements one or more CAB services for operating on stored CAB information. For example, the CAB servers 105, 125 each implement an address book management service, a personal contact card management service, a contact subscription service, a contact share service, an import non-CAB data service, as well as any other CAB-related services. The CAB server 105 provides its CAB services to the CAB clients, including the CAB client 110, operating in its domain 115. Similarly, the CAB server 125 provides its CAB services to the CAB clients, including the CAB client 130, operating in its domain 135. As part of some or all of these services, the CAB server 105 will notify the CAB client 110 of the occurrence of certain CAB events, whereas the CAB server 125 will notify the CAB client 130 of the occurrence of certain CAB events. For example, events for which the CAB server 105 will provide notifications include, but are not limited to: (a) an address book contact add event indicating that a CAB user associated with the CAB client 110 is added as a contact in another CAB user's address book; (b) a new CAB user event indicating that a non-CAB user in the address book of the CAB user associated with the CAB client 110 has become a CAB user; (c) a contact subscription request event indicating that the CAB user associated with the CAB client 110 is the target of a contact subscription request being made by another CAB user, which permits reactive authorization in which the CAB client 110 can respond by allowing or rejecting the incoming contact subscription request, etc. The CAB server 125 may provide notifications for similar or different events to the CAB client 130.

To support the exchange of event notification information among multiple network domains, such as between the domains 115 and 135, the CAB system 100 of FIG. 1 includes the network repository 140. In the illustrated example, the network repository 140 is implemented as a CAB XDMS 140 for storing and managing XML documents used to exchange CAB-related information in the home domain 115, such as between the CAB server 105 and the CAB client 110. The CAB server 105 is also accessible by a remote CAB server, such as the CAB server 125, via one or more NNIs described in greater detail below. In addition to supporting conventional CAB services, the CAB XDMS 140 allows a home CAB server (such as the CAB server 105) to write CAB event information for CAB events involving CAB users in another remote domain (such as the domain 135) to the network repository for subsequent retrieval by a remote CAB server (such as the remote CAB server 125) serving that remote domain. The remote CAB server can then process the CAB event information retrieved from CAB XDMS 140 and provide an appropriate event notification to the affected CAB client (such as the CAB client 130). In an example implementation, the CAB system 100 and, more specifically, the CAB servers 105, 125 and the CAB XDMS 140 exchange CAB event-related information according to an example CAB NNI events list application usage. The CAB NNI events list application usage is an XDM application usage specifying the schema (e.g., syntax) and semantics (e.g., meaning, behavior, and possibly limits) of the CAB event-related information to be exchanged among multiple network domains.

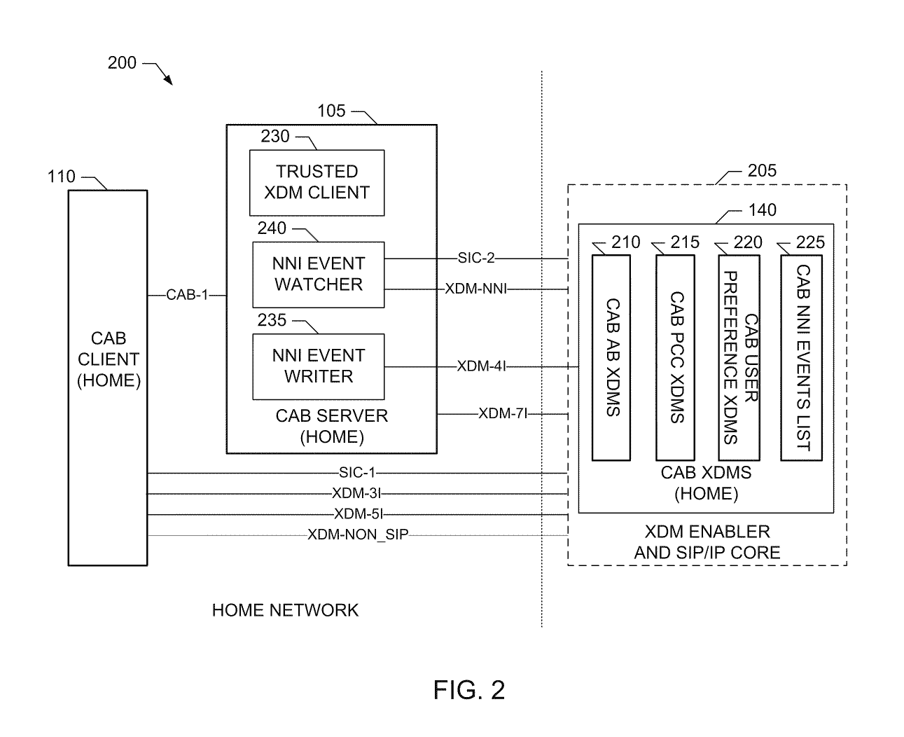

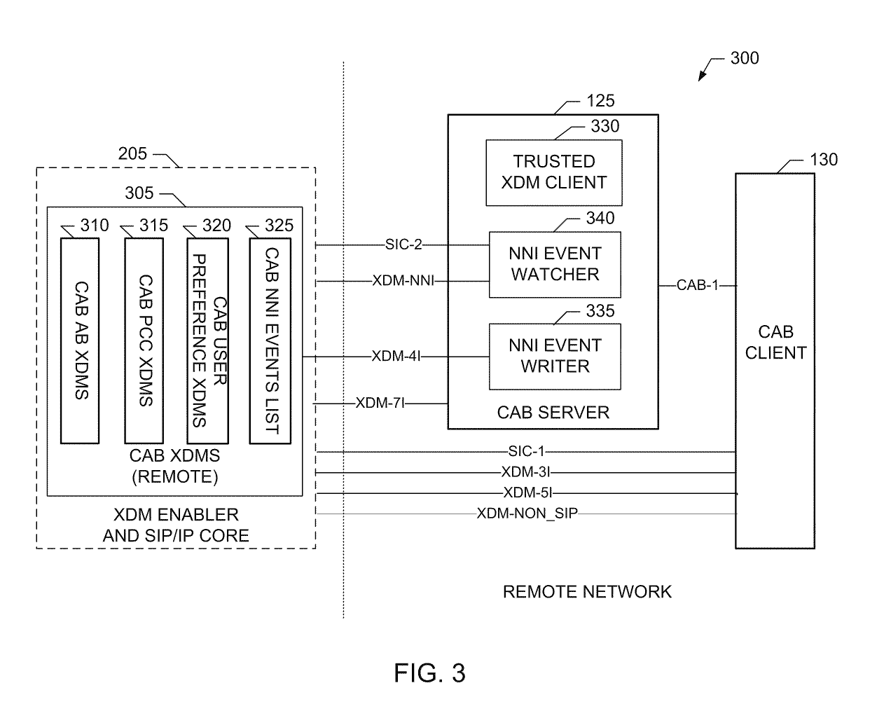

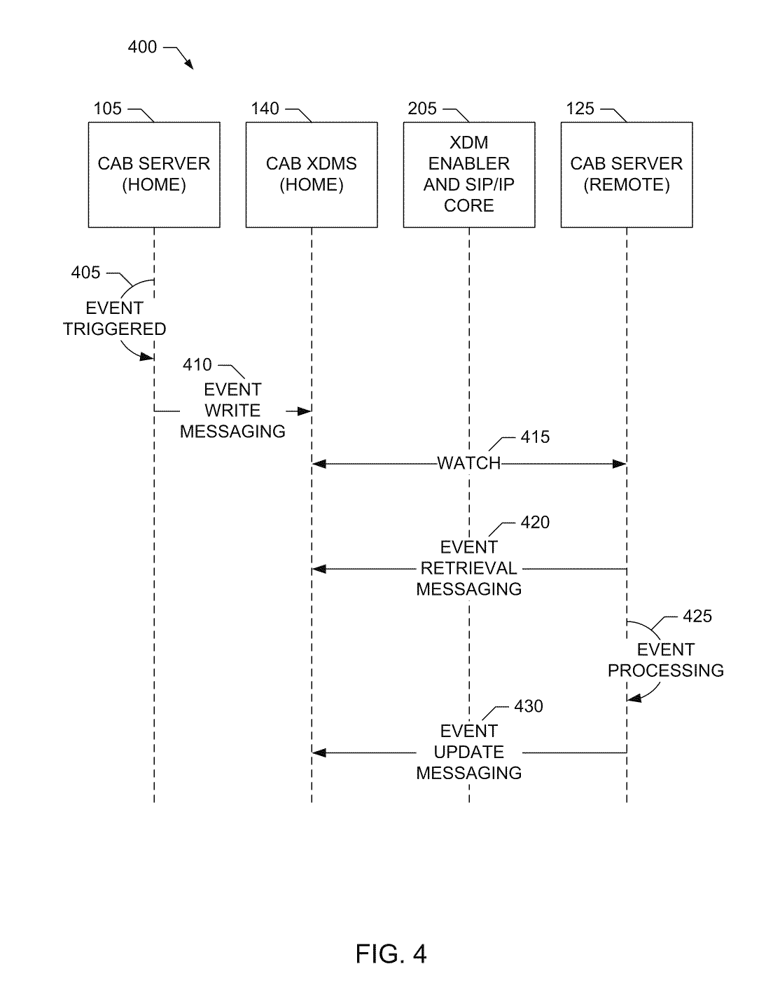

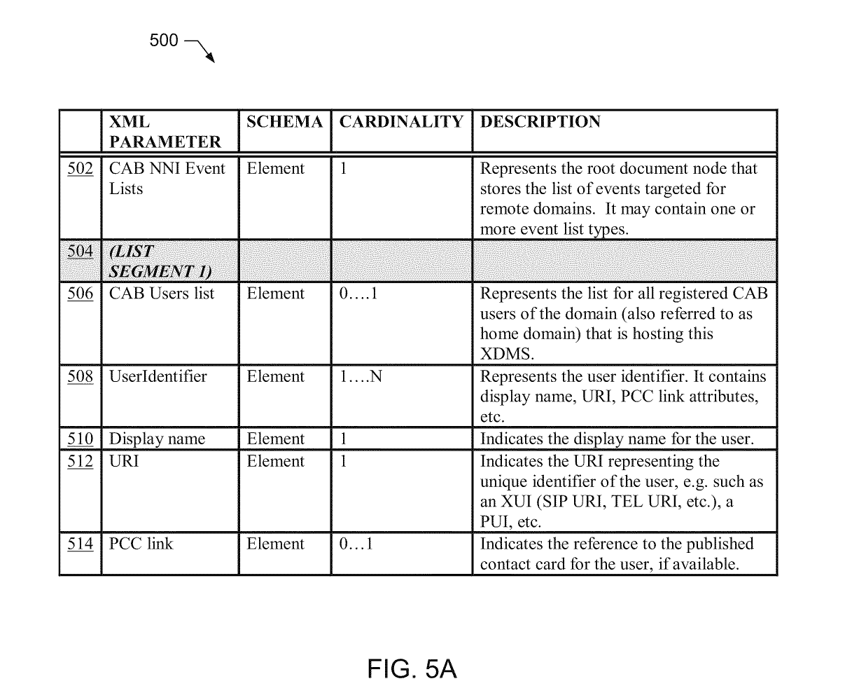

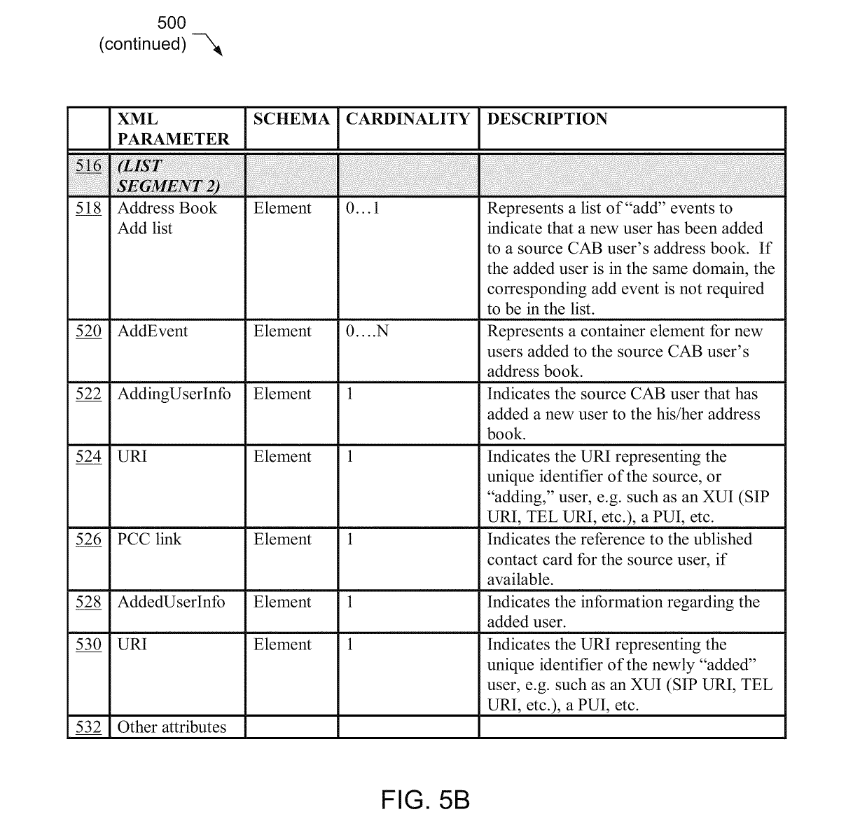

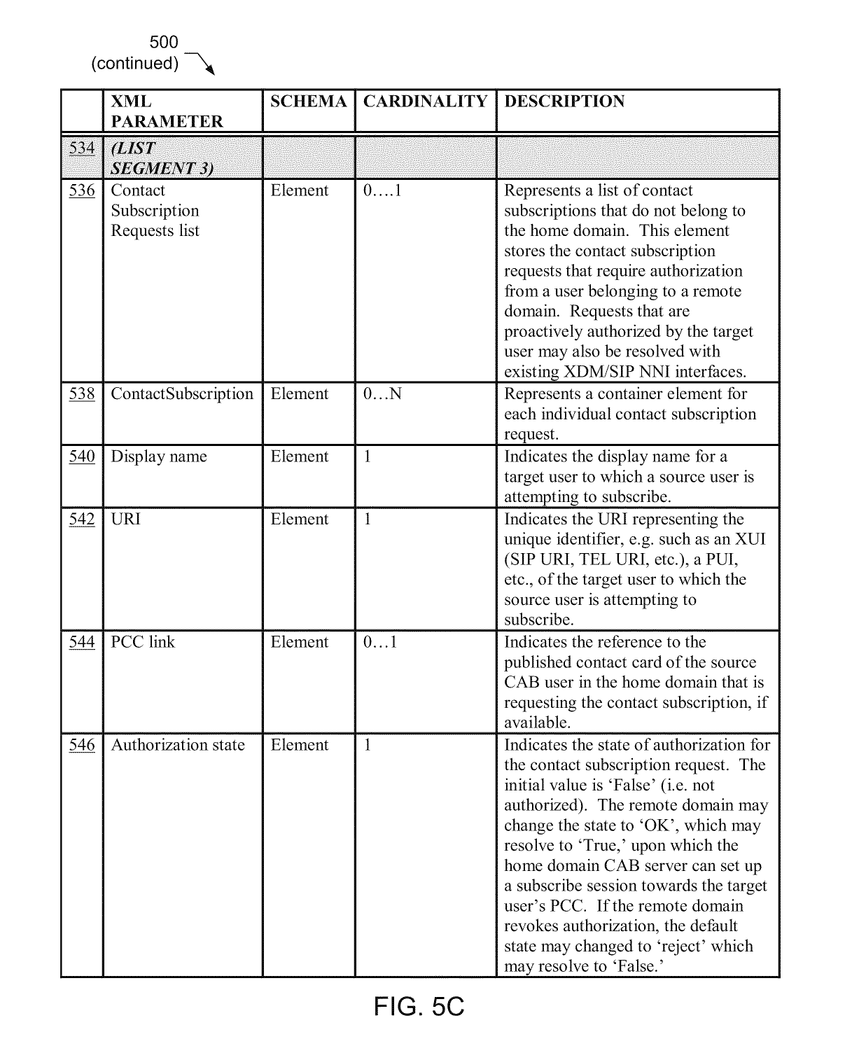

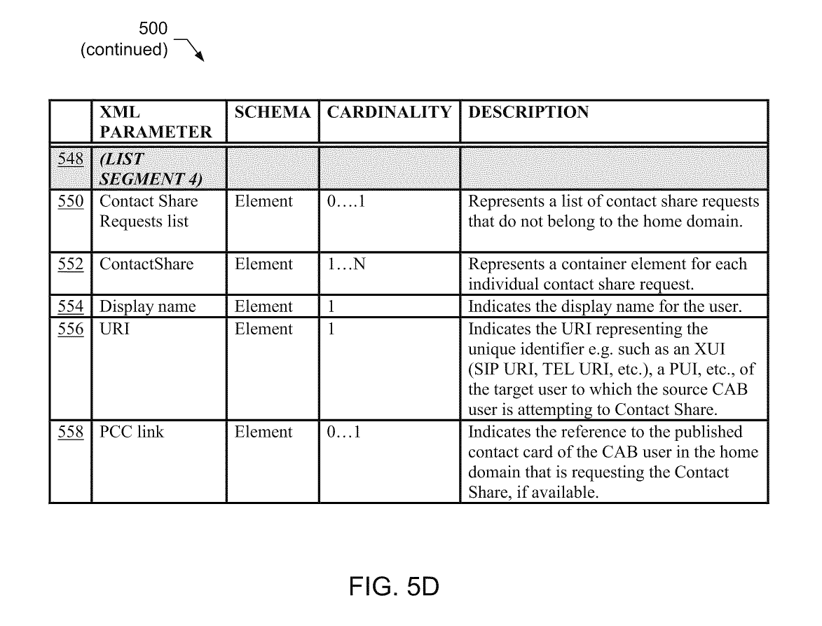

Example implementations of the CAB server 105 and the CAB client 110 in the first network domain 115 are illustrated in FIG. 2. Example implementations of the CAB server 125 and the CAB client 130 in the second network domain 125 are illustrated in FIG. 3. Examples of messaging to exchange CAB event-related information between the CAB server 105 in the first network domain 115 and the CAB server 125 in the second network domain 135 is illustrated in FIG. 4. An example CAB NNI events list application usage is illustrated in FIGS. 5A-D. Furthermore, although the example CAB system 100 of FIG. 1 is depicted has including two CAB server 105 and 125, two CAB clients 110 and 130, and one CAB XDMS 140, any number of CAB clients, CAB servers and CAB XDMSs could be included in the CAB system 100. For example, another CAB XDMS (e.g., such as the CAB XDMS 305 of FIG. 3) could be included in the CAB system 100 to operate as the CAB network repository for the remote domain 135. Furthermore, the example methods and apparatus described herein can be implemented in any CAB system architecture, such as the architecture described in OMA's “Converged Address Book Architecture,” Draft Version 1.0, OMA-AD-CAB-V1_{—}0-20090827-D (Aug. 27, 2009), which is publicly available.

An example CAB system 200 including example implementations of the CAB server 105, the CAB client 110, and the CAB XDMS 140 of FIG. 1 is illustrated in FIG. 2. As shown in the CAB system 200 of FIG. 2, the CAB client 110 is communicatively coupled with the CAB server 105 via a CAB-1 interface, the CAB client 110 is communicatively coupled with the CAB XDMS 140 via SIC-1, XDM-3i, XDM-5i and XDM-NON_SIP interfaces, and the CAB server 105 is communicatively coupled with the CAB XDMS 140 via SIC-2, XDM-4i, XDM-7i and XDM-NNI interfaces. Examples of the CAB-1, SIC-1, SIC-2, XDM-3i, XDM-4i, XDM-5i and XDM-7i interfaces are defined in the OMA's “Converged Address Book Architecture,” referenced above. The XDM-NNI interface is discussed in greater detail below. In the illustrated example, the SIC-1 and SIC-2 interfaces employ the session initiation protocol (SIP), the various XDM interfaces employ an XML configuration access protocol (XCAP) based on the hypertext transfer protocol (HTTP), and the CAB-1 interface also employs a protocol based on HTTP, such as the SyncML protocol.

Also, as shown in the CAB system 200 of FIG. 2, the CAB XDMS 140 is implemented according to the OMA XDM enabler specifications and is included in a core network functional element 205 supporting SIP and Internet protocol (IP) communications. The core network functional element 205 also includes various aggregation and cross-network proxy elements implementing the NNIs that enable interaction among CAB servers in different trusted domains, such as the domains 115 and 135 of FIG. 1. Interaction with CAB servers in different domains via the NNIs provided by the core network functional element 205 is achieved through a trusted XDM client 230 associated with the CAB server 105. Additionally, the CAB XDMS 140 includes one or more constituent XDMSs to store, manage, transform, share and otherwise process contact information among CAB servers and CAB clients. For example, the CAB XDMS 140 includes a CAB address book (AB) XDMS 210 dedicated to address book information, a CAB personal contact card (PCC) XDMS 215 dedicated to a user's own personal contact information and a CAB user preference XDMS 220 dedicated to storing user preferences and supporting service requests and customization rules. More detailed descriptions of the functionality supported by the CAB AB XDMS 210, the CAB PCC XDMS 215 and the CAB user preference XDMS 220 are provided in OMA's “Converged Address Book Architecture,” referenced above.

Furthermore, in at least some example implementations, the CAB NNI events list application usage mentioned above and described in greater detail below in conjunction with FIGS. 5A-D is implemented by a separate, constituent CAB NNI events list XDMS 225 included in the CAB XDMS 140. Alternatively, the CAB NNI events list application usage can be implemented by part or any one or more of the other constituent XDMSs 210-220 included in the CAB XDMS 140.

To enable the exchange of event notification information among multiple network domains, the CAB server 105 of FIG. 2 further includes an NNI event writer 235 and an NNI event watcher 240. The NNI event writer 235, the NNI event watcher 240, or both, may be implemented as distinct physical or logical functional units, or as part of one or more existing physical or logical functional units, such as the trusted XDM client 230, in the CAB server 105.

The NNI event writer 235 is included in the CAB server 105 to write CAB event-related information to one or more CAB NNI events lists maintained by the CAB server 105 in its home CAB NNI events list XDMS 225. For example, the NNI event writer 235 may be configured to write CAB event-related information via the XDM-4i interface to a CAB NNI events list maintained in the CAB NNI events list XDMS 225 for only those CAB events involving a CAB user not operating in the home domain of the CAB server 105. Alternatively, the NNI event writer 235 may be configured to write CAB event-related information to the CAB NNI events list for all CAB events processed by the CAB server 105. In yet another example, for certain types of events, the NNI event writer 235 may be configured to write CAB event-related information to the CAB NNI events list for only those CAB events involving a CAB user not operating in the home domain of the CAB server 105, whereas for other events the NNI event writer 235 may write all of the associated event-related information to the CAB NNI events list. Examples of the schema and semantics for the CAB event-related information that can be written by the NNI event writer 235 to its associated CAB NNI events list(s) for different types of events is illustrated in the CAB NNI events list application usage of FIGS. 5A-D, which is described in greater detail below.

The NNI event watcher 240 is included in the CAB server 105 to monitor, or watch, for changes in one or more CAB NNI events lists maintained in one or more remote CAB NNI events list XDMSs (such as the CAB NNI events list XDMS 325 shown in FIG. 3 and discussed below) by one or more remote CAB servers operating in one or more remote network domains (such as the CAB server 125). For example, the NNI event watcher 240 (e.g., in conjunction with the trusted XDM client 230) may subscribe for notifications of changes in the CAB event-related information stored in one or more remote CAB NNI events list XDMSs (such as the CAB NNI events list XDMS 325 shown in FIG. 3 and discussed below). In such an example, the NNI event watcher 240 subscribes to such notifications of changes in the CAB event-related information using SIP SUBSCRIBE/NOTIFY messaging conveyed via the SIC-2 interface. Then, the NNI event watcher 240 can utilize a push mechanism resulting from this NNI event subscription to automatically receive notifications via the SIC-2 interface of changes to the CAB NNI events list(s) of remote CAB server(s) to which the NNI event watcher 240 has subscribed. The NNI event watcher 240 may then retrieve the associated event-related information via the XDM-NNI interface and associated NNI interface(s) provided by the core network functional element 205 (e.g., such as an aggregation proxy, a cross network proxy in the home network domain, and a cross network proxy in the remote network domain). Additionally or alternatively, the NNI event watcher 240 (e.g., in conjunction with the trusted XDM client 230) may utilize a pull mechanism in which the NNI event watcher 240 utilizes any polling mechanism or event-driven mechanism, or both, over the XDM-NNI interface and associated NNI interface(s) (via XCAP and/or XQuery operations) provided by the core network functional element 205 (e.g., such as an aggregation proxy, a cross network proxy in the home network domain, and a cross network proxy in the remote network domain) to process each remote CAB NNI events list of interest to determine whether any changes have occurred.

When the NNI event watcher 240 detects a change in the CAB event-related information maintained in a monitored, or watched, remote CAB NNI events list, the NNI event watcher 240 determines whether the changed event information involves a CAB user served by the CAB server 105 (e.g., such as the CAB user associated with the CAB client 110 operating in the home domain 115 of the CAB server 105). If the changed event information involves a CAB user served by the CAB server 105, the CAB server 105 processes the event information maintained in the remote CAB NNI events list for this event and conveys an appropriate event notification to notify the affected CAB user (e.g., such as the CAB user associated with the CAB client 110) of the event. For certain types of events, the NNI event watcher 240 may also update the associated event-related information stored in a CAB NNI events list being maintained by a remote CAB server different from the CAB server 105. Examples of the schema and semantics for the CAB event-related information that can be monitored, or watched, by the NNI event watcher 240 is illustrated in the CAB NNI events list application usage of FIGS. 5A-D, which is described in greater detail below.

In at least some example implementations, the NNI event watcher 240 may employ aggregation (or batching) of notifications in some scheduled manner (such as hourly, daily, etc.) to reduce the processing load of the CAB server 105 or the network traffic caused by exchanging CAB event-related information in the CAB system 200, or both.

An example CAB system 300 including example implementations of the CAB server 125 and the CAB client 130 of FIG. 1 is illustrated in FIG. 3. FIGS. 2 and 3 share some elements in common and, thus, like elements are labeled with the same reference numerals. The detailed descriptions of these like elements, such as the core network functional element 205, are provided above in connection with the discussion of FIG. 2 and, in the interest of brevity, are not repeated in the discussion of FIG. 3. Additionally, in FIG. 3, the CAB XDMS 305 (and its constituent CAB AB XDMS 310, CAB PCC XDMS 315, CAB user preference XDMS 320 and CAB NNI events list XDMS 325) provides home CAB XDMS functionality for the CAB server 125 in FIG. 3 in a manner similar to the home CAB XDMS functionality provided to the CAB server 105 in FIG. 2 by the CAB XDMS 140 (and its constituent CAB AB XDMS 210, CAB PCC XDMS 215, CAB user preference XDMS 220 and CAB NNI events list XDMS 225). Furthermore, the trusted XDM client 330, the NNI event writer 335 and the NNI event watcher 340 illustrated in FIG. 3 are similar to the respective trusted XDM client 230, the NNI event writer 235 and the NNI event watcher 240 illustrated in FIG. 2.

While example manners of implementing the CAB systems 100, 200 and 300 have been illustrated, respectively, in FIGS. 1, 2 and 3, one or more of the elements, processes and/or devices illustrated in FIGS. 1-3 may be combined, divided, re-arranged, omitted, eliminated and/or implemented in any other way. Further, the example CAB server 105, the example CAB client 110, the example CAB server 125, the example CAB client 130, the example CAB XDMS 140, the example CAB AB XDMS 210, the example CAB PCC XDMS 215, the example CAB user preference XDMS 220, the example CAB NNI events list XDMS 225, the example trusted XDM client 230, the example NNI event writer 235, the example NNI event watcher 240, the example CAB XDMS 305, the example CAB AB XDMS 310, the example CAB PCC XDMS 315, the example CAB user preference XDMS 320, the example CAB NNI events list XDMS 325, the example trusted XDM client 330, the example NNI event writer 335, the example NNI event watcher 340 and/or, more generally, the example CAB systems 100, 200 and/or 300 of FIGS. 1-3 may be implemented by hardware, software, firmware and/or any combination of hardware, software and/or firmware. Thus, for example, any of the example CAB server 105, the example CAB client 110, the example CAB server 125, the example CAB client 130, the example CAB XDMS 140, the example CAB AB XDMS 210, the example CAB PCC XDMS 215, the example CAB user preference XDMS 220, the example CAB NNI events list XDMS 225, the example trusted XDM client 230, the example NNI event writer 235, the example NNI event watcher 240, the example CAB XDMS 305, the example CAB AB XDMS 310, the example CAB PCC XDMS 315, the example CAB user preference XDMS 320, the example CAB NNI events list XDMS 325, the example trusted XDM client 330, the example NNI event writer 335, the example NNI event watcher 340 and/or, more generally, the example CAB systems 100, 200 and/or 300 could be implemented by one or more circuit(s), programmable processor(s), application specific integrated circuit(s) (ASIC(s)), programmable logic device(s) (PLD(s)) and/or field programmable logic device(s) (FPLD(s)), etc. In some instances, at least one of the example CAB systems 100, 200 and/or 300, the example CAB server 105, the example CAB client 110, the example CAB server 125, the example CAB client 130, the example CAB XDMS 140, the example CAB AB XDMS 210, the example CAB PCC XDMS 215, the example CAB user preference XDMS 220, the example CAB NNI events list XDMS 225, the example trusted XDM client 230, the example NNI event writer 235, the example NNI event watcher 240, the example CAB XDMS 305, the example CAB AB XDMS 310, the example CAB PCC XDMS 315, the example CAB user preference XDMS 320, the example CAB NNI events list XDMS 325, the example trusted XDM client 330, the example NNI event writer 335 and/or the example NNI event watcher 340 are hereby expressly defined to include a tangible medium such as a memory, digital versatile disk (DVD), compact disk (CD), etc., storing such software and/or firmware. Further still, the example CAB systems 100, 200 and/or 300 of FIGS. 1-3 may include one or more elements, processes and/or devices in addition to, or instead of, those illustrated in FIGS. 1-3 and/or may include more than one of any or all of the illustrated elements, processes and devices.

An example message sequence diagram 400 illustrating example messaging to exchange CAB event-related information among multiple network domains in the example CAB systems 100-300 of FIGS. 1-3 is illustrated in FIG. 4. The message sequence diagram 400 begins with the home CAB server 105 detecting a CAB event in the home domain 115 (represented as a directed line 405). Examples of CAB events that may be detected by the home CAB server 105 at line 405 include, but are not limited to: (a) an address book add event triggered when the CAB server 105 detects that a CAB user associated with a CAB client in the home domain 115 (such as the CAB client 110) has added a new user contact entry in his/her address book; (b) a new CAB user event triggered when the CAB server 105 detects that a non-CAB user has signed-up to be a CAB user and to receive CAB service from the CAB server 105; (c) a contact subscription request event triggered when the CAB server 105 detects that a CAB user associated with a CAB client in the home domain 115 (such as the CAB client 110) has made a contact subscription request having a target CAB user operating in a remote domain (such as a target CAB user associated with the CAB client 125 in the remote domain 135); etc.

In response to detecting the CAB event (line 405), the home CAB server 105 performs event write messaging 410 to write event information related to the detected CAB event to a home CAB NNI events list maintained by the CAB server 105 in the CAB XDMS 140 (e.g., such as in the constituent CAB NNI events list XDMS 225). For example, the event write messaging 410 may correspond to one or more XCAP messages, such as an XCAP PUT message, exchanged via the XDM-4i interface and the event information may be written to the CAB NNI events list according to the CAB NNI events list application usage 500 illustrated in FIGS. 5A-D and described in detail below.

Next, the remote CAB server 125 monitors, or watches, the CAB NNI events list maintained by the CAB server 105 in the CAB XDMS 140 via one or more NNI interfaces provided by the core network functional element 205. The monitoring/watching of the CAB NNI events list maintained by the CAB server 105 in the CAB XDMS 140 is represented by a directed line 415. When an update of the monitored/watched CAB NNI events list is detected, the remote CAB server 125 performs event retrieval messaging 420 to retrieve the associated CAB event information from the CAB NNI events list. In an example implementation, the remote CAB server 125 may implement the monitoring/watching at line 415 and event retrieval messaging 420 using a SIP SUBSCRIBE/NOTIFY mechanism over the SIC-2 interface and SIP/IP core provided by the core network functional element 205, a polling mechanism employing XCAP GET or XQuery exchanges over the XDM-NNI interface and the associated aggregation and cross-network proxies provided by the core network functional element 205, etc., or any combination thereof.

Next, the remote CAB server 125 analyzes and processes the retrieved CAB event information (represented as a directed line 425) to deliver any relevant notifications to the CAB client(s) operating in the remote domain 135. Examples of the CAB event processing performed at block 425 includes, but is not limited to: (a) notifying a CAB user in the remote domain 135 served by the remote CAB server 125 that the CAB user has been added to another (e.g., home) CAB user's address book; (b) notifying a CAB user in the remote domain 135 that a non-CAB user in his/her address become has become a new CAB user; (c) notifying a target CAB user in the remote domain 135 that another (e.g., home) CAB user is requesting a contact subscription that will provide the other user with notification(s) when changes are made to the target CAB user's contact information (e.g., such as when changes are made to the target user's personal contact card). Such notifications can be performed by any appropriate notification mechanism, such as by using an OMA PUSH enabler, updating contact status fields in a CAB user's address book, placing notifications in an XML document to which the CAB user can subscribe, etc.

Depending upon the type of CAB event corresponding to the retrieved event information, the remote CAB server 125 may perform event update messaging 430 to update certain event information in the home CAB NNI events list maintained by the CAB server 105 in the CAB XDMS 140. The event update messaging 430 may correspond to one or more XCAP messages, such as an XCAP PUT message, exchanged via the XDM-NNI interface and the associated aggregation and cross-network proxies provided by the core network functional element 205. For example, if the retrieved event information corresponds to a contact subscription request, then the remote CAB server 125 may need to update the retrieved event information to set an acknowledgment status of the contact subscription request indicating whether the target CAB user in the remote domain 135 has accepted or denied the request. In such an example, the home CAB server 105 retrieves the updated acknowledgment status to complete processing of the contact subscription request (e.g., by subscribing to the CAB PCC XDMS of the remote CAB user if the contact subscription request was accepted).

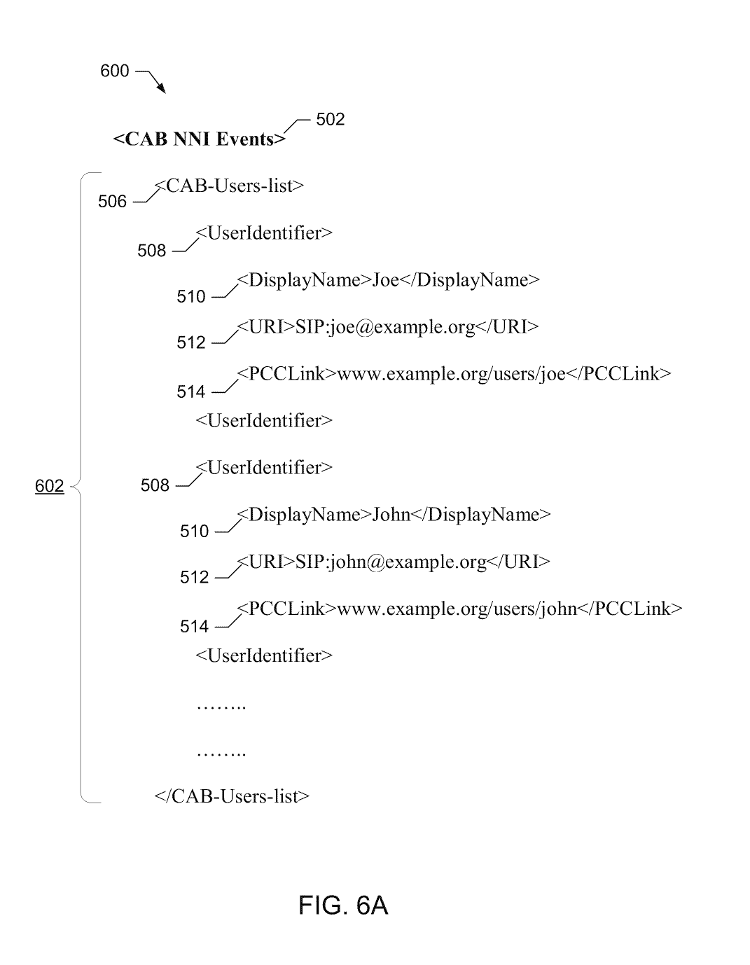

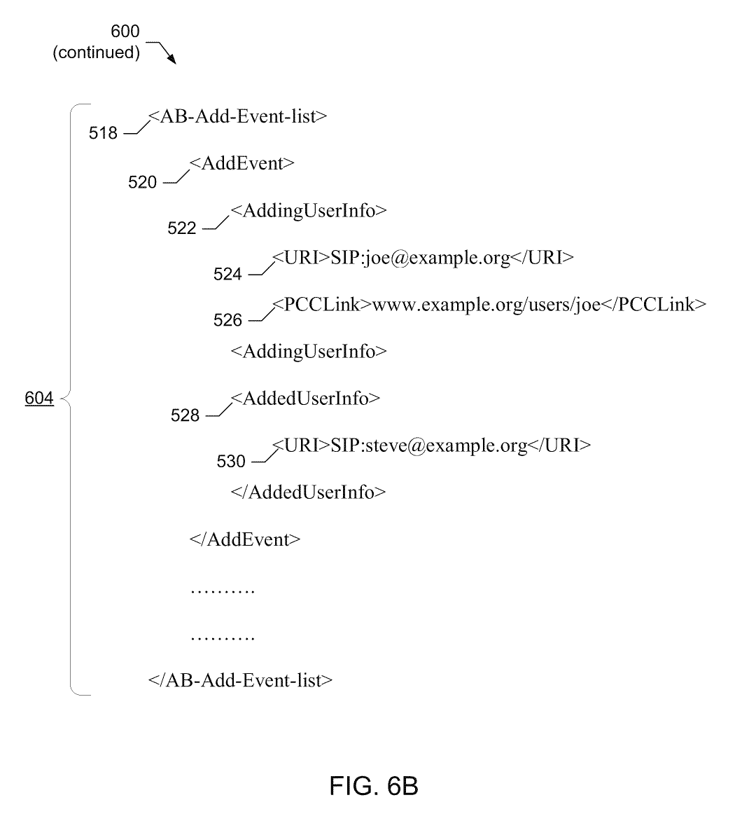

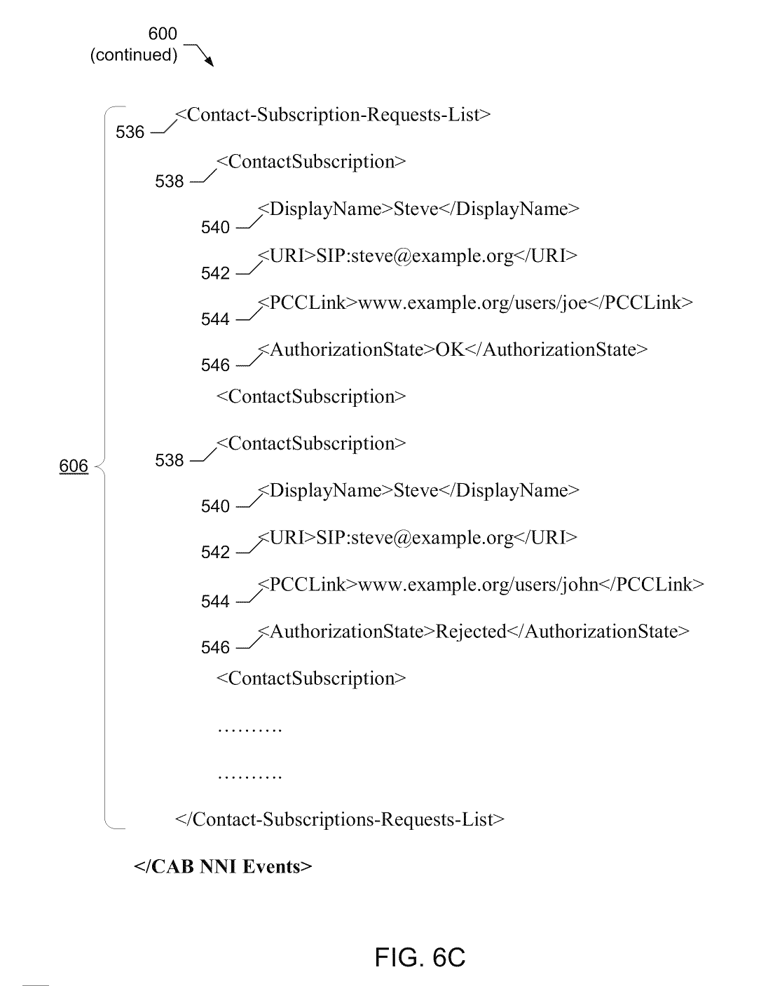

An example CAB NNI events list application usage 500 specifying the syntax/schema for formatting CAB event-related information for storage in one or more CAB NNI events lists (e.g., implemented as XML documents) at the CAB NNI events list XDMS 225 is illustrated in FIGS. 5A-D. The elements defined in the schema represented by the table of FIGS. 5A-D are examples of the parameters that may be defined to support an application usage for exchanging event-related information among multiple network domains, and the actual schema may be different for different example implementations. In the following, the example CAB NNI events list application usage 500 is described in the context of the example CAB NNI events list fragment 600 (implemented as an XML list fragment) illustrated in FIGS. 6A-C. In particular, an example CAB user event list fragment 602 is illustrated in FIG. 6A, an example address book add event list fragment 604 is illustrated in FIG. 6B, and an example contact subscription request event list fragment is illustrated in FIG. 6C.

The example CAB NNI events list application usage 500 begins with a CAB NNI events list element 502 corresponding to the root node of the application usage and representing the start of a CAB NNI events list maintained by a particular CAB server (e.g., such as the CAB server 105). Next, the CAB NNI events list application usage 500 includes various constituent lists representing different event(s) that may be maintained in a particular CAB NNI events list. For example, the CAB NNI events list application usage 500 includes a first list 504 represented by a CAB users list element 506. The CAB users list element 506 represents a list of all registered CAB users in the domain served by the CAB server (e.g., such as the CAB server 105) maintaining the CAB NNI events list. The CAB users list element 506 can be monitored and processed by a remote CAB server (e.g., such as the CAB server 125) to generate appropriate new CAB user event notifications, as described in greater detail below.

Each CAB user included in the CAB users list element 506 is represented by a user identifier element 508, a display name element 510, a uniform resource identifier (URI) element 512 and a PCC link element 514. The user identifier element 508 represents a container for the associated display name element 510, URI element 512 and PCC link element 514. The display name element 510 represents the CAB user's name as it is to be displayed in the CAB system. The URI element 512 represents any appropriate unique identifier for the CAB user, such as an XCAP user identifier (XUI), a SIP URI, a TELephone (TEL) URI, a public user identifier (PUI), etc. The PCC link element 514 represents a reference to a personal contact card for the CAB user, if one is available.

An example of using the CAB users list element 506, the user identifier element 508, the display name element 510, the URI element 512 and the PCC link element 514 in the context of exchanging CAB event-related information associated with a new CAB user event is illustrated FIG. 6A.

The CAB NNI events list application usage 500 also includes a second list 516 represented by an address book add list element 518. The address book add list element 518 represents a list of all address book add events associated with CAB user address managed by the CAB server (e.g., such as the CAB server 105) maintaining the CAB NNI events list. An address book add event occurs when a new user is added to a CAB address book. In an example implementation, the address book add list element 518 includes only those address book add events involving an added user that is not in the home domain of the CAB server (the CAB server 105) maintaining the CAB NNI events list. The address book add list element 518 can be monitored and processed by a remote CAB server (e.g., such as the CAB server 125) to generate appropriate address book add event notifications, as described in greater detail below.

Each address book add event included in the address book add list element 518 is represented by an add event element 520, an adding user info element 522, a URI element 524, a PCC link element 526, an added user info element 528 and a URI element 530. The add event element 520 represents a container for the adding user info element 522, URI element 524, PCC link element 526, added user info element 528 and URI element 530 associated with a particular address book add event. The adding user info element 522 represents the CAB user that caused the address book add event by adding the new user to his/her address book (referred to as the “adding CAB user”). The URI element 524 represents any appropriate unique identifier for the adding CAB user. The PCC link element 526 represents a reference to a personal contact card for the adding CAB user, if one is available. The added user info element 528 represents the user that was added to the adding CAB user's address book (referred to as the “added user”). In other words, the added user info element 528 represents the added user that needs to be notified that it was the target of an address book add event. The URI element 530 represents any appropriate unique identifier for the added CAB user. The address book add list element 518 may also include any other attributes 532 that are appropriate to a particular example implementation.

An example of using the address book add list element 518, the adding user info element 522, the URI element 524, the PCC link element 526, the added user info element 528 and the URI element 530 in the context of exchanging CAB event-related information associated with an address book add event is illustrated FIG. 6B.

The CAB NNI events list application usage 500 further includes a third list 534 represented by a contact subscription requests list element 536. The contact subscription requests list element 536 represents a list of contact subscription request events targeted to CAB users that are not in the home domain of the CAB server (e.g., such as the CAB server 105) maintaining the CAB NNI events list. The contact subscription requests list element 536 can be monitored and processed by a remote CAB server (e.g., such as the CAB server 125) to generate appropriate contact subscription request notifications, as described in greater detail below.

Each contact subscription request event included in the contact subscription requests list element 536 is represented by a contact subscription element 538, a display name element 540, a URI element 542, a PCC link element 544, and an authorization state element 546. The contact subscription element 538 represents a container for the display name element 540, URI element 542, PCC link element 544, and authorization state element 546 associated with a particular contact subscription request event. The display name element 540 represents the display name of the target CAB user that is the subject of the contact subscription request. The URI element 542 represents any appropriate unique identifier for this target CAB user. The PCC link element 544 represents a reference to a personal contact card for the source CAB user that is requesting the contact subscription. The authorization state element 546 represents the authorization state of the contact subscription request. In an example implementation, the home CAB server (e.g., such as the CAB server 105) initially sets the authorization state element 546 to ‘FALSE’ to indicate that contact subscription to the target CAB user has not been authorized by the target CAB user or that an authorization from the target CAB permitting a direct contact subscription to the target user's personal contact card is still pending. The remote CAB server (e.g., such as the CAB server 125) then updates the authorization state element 546 to ‘OK’ or ‘REJECT’ depending upon whether the target CAB user allows or rejects the contact subscription request.

An example of using the contact subscription requests list element 536, the user identifier element 508, the contact subscription element 538, the display name element 540, the URI element 542, the PCC link element 544 and the authorization state element 546 in the context of exchanging CAB event-related information associated with a contact subscription request event is illustrated FIG. 6C.

The CAB NNI events list application usage 500 further includes a fourth list 548 represented by a contact share requests list element 550. The contact share requests list element 550 represents a list of contact share request events targeted to CAB users that are not in the home domain of the CAB server (e.g., such as the CAB server 105). The contact share requests list element 550 includes a contact share element 552, a display name element 554, a URI element 556 and a PCC link element 558, as depicted in FIG. 5D. Similar to the other list elements, the contact share requests list element 550 can be monitored and processed by a remote CAB server (e.g., such as the CAB server 125) to generate appropriate contact share request notifications.

Clean up of the component lists 504, 516, 534, 548, etc., included in a CAB NNI events list implemented according to the CAB NNI events list application usage 500 may be performed using various mechanisms. A first example clean-up mechanism removes elements from a component list in a CAB NNI events list when processing of the associated event is completed. For example, in the case of the list 534 corresponding to the contact subscription requests list element 536, elements associated with a particular contact subscription element 538 may be removed from the CAB NNI events list when the associated contact subscription request has been processed (e.g., after the associated authorization state element 546 has been updated by the remote CAB server and operated on by the home CAB server).

A second example clean-up mechanism involves removing stale elements from the CAB NNI events list associated with events that have expired or for which the source or target CAB user, or both, has terminated service. A third example clean-up mechanism involves removing elements from the CAB NNI events list associated with events that are overridden by other events. For example, a source CAB user may make a duplicate contact subscription request to a same target CAB user generating a contact subscription event, or the source CAB user may also add a target CAB user to the source user's address book generating an address book event, which results in duplicate events for the same purpose. In such cases, the more recent event may override the older event, allowing the elements in the CAB NNI events list associated with the older event to be removed.

In an example implementation, a home CAB server in a home domain writes CAB event-related information to a CAB NNI events list according to the CAB NNI events list application usage 500. Subsequently, a remote CAB server in a remote domain processes the CAB NNI events list according to the CAB NNI events list application usage 500 to determine whether any of the stored events need to be notified to a CAB user served by the remote CAB server. Such notifications can be performed by any appropriate notification mechanism, such as by using an OMA PUSH enabler, updating contact status fields in a CAB user's address book, placing notifications in an XML document to which the CAB user can subscribe, etc.

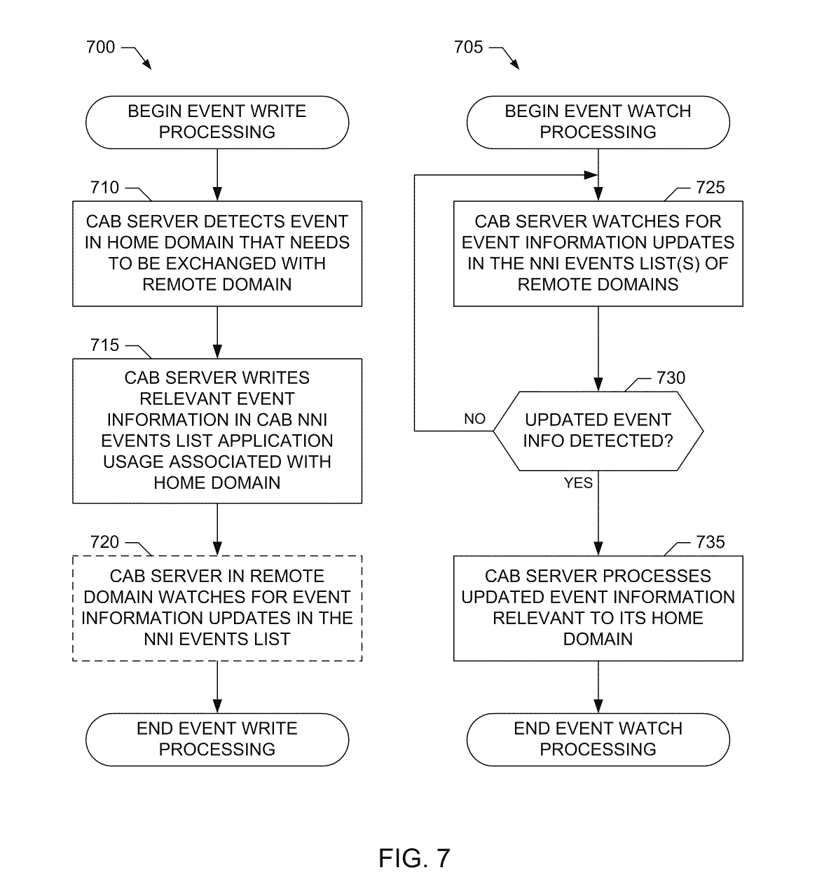

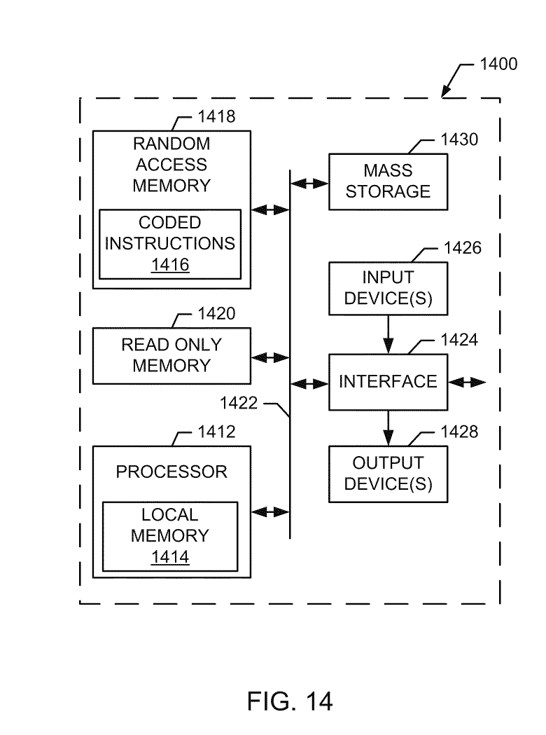

Flowcharts representative of example processes that may be executed to implement any or all of the example CAB systems 100, 200 and 300, the example CAB servers 115 and 125, the example CAB XDMS 140, the example CAB AB XDMS 210, the example CAB PCC XDMS 215, the example CAB user preference XDMS 220, the example CAB NNI events list XDMS 225, the example trusted XDM client 230, the example NNI event writer 235, the example NNI event watcher 240, the example CAB XDMS 305, the example CAB AB XDMS 310, the example CAB PCC XDMS 315, the example CAB user preference XDMS 320, the example CAB NNI events list XDMS 325, the example trusted XDM client 330, the example NNI event writer 335, the example NNI event watcher 340 shown in FIGS. 7-13. In these examples, the process represented by each flowchart may be implemented by one or more programs comprising machine readable instructions for execution by: (a) a processor, such as the processor 1412 shown in the example processing system 1400 discussed below in connection with FIG. 14, (b) a controller, and/or (c) any other suitable device. The one or more programs may be embodied in software stored on a tangible medium such as, for example, a flash memory, a CD-ROM, a floppy disk, a hard drive, a DVD, or a memory associated with the processor 1412, but the entire program or programs and/or portions thereof could alternatively be executed by a device other than the processor 1412 and/or embodied in firmware or dedicated hardware (e.g., implemented by an application specific integrated circuit (ASIC), a programmable logic device (PLD), a field programmable logic device (FPLD), discrete logic, etc.).

Some or all of the processes represented by the flowcharts of FIGS. 7-13 may be implemented manually. Further, although the example processes are described with reference to the flowcharts illustrated in FIGS. 7-13, many other techniques for implementing the example methods and apparatus described herein may alternatively be used. For example, with reference to the flowcharts illustrated in FIGS. 7-13, the order of execution of the blocks may be changed, and/or some of the blocks described may be changed, eliminated, combined and/or subdivided into multiple blocks.

Example processes 700 and 705 that may be performed (e.g., executed) to implement functionality in the CAB server 105, the CAB server 125, or both, for exchanging CAB event-related information among multiple network domains is illustrated in FIG. 7. The example process 700 implements a generic event write process that may be performed (e.g., executed), for example, whenever the CAB server 105, 125 is to write CAB event-related information associated with one or more CAB events to a home CAB NNI events list stored, for example, in the CAB NNI events list XDMS 225, 325. The example process 705 implements a generic event watch process that may be performed (e.g., executed), for example, whenever the CAB server 105, 125 is to monitor, or watch, for updates of CAB event-related information maintained by a remote CAB server in a remote CAB NNI events list stored, for example, in the CAB NNI events list XDMS 325, 225. Furthermore, the CAB server 105, 125 may perform (e.g., execute) the processes 700 and 705 in parallel, in serial, or in any combination of parallel and serial processing.

While the processes 700 and 705 may be implemented by one or both of the CAB server 105 and the CAB server 125 in any or all of the CAB systems 100, 200 and 300, for brevity and clarity, operation of the processes 700 and 705 is described from the perspective of implementation by the CAB server 105 in the CAB systems 100 and 200. Thus, with reference to FIGS. 1-2, and with reference to the CAB NNI events list application usage 500 illustrated in FIGS. 5A-D, the process 700 of FIG. 7 begins at block 710 at which the CAB server 105 detects a CAB event in the home domain 115 that involves a CAB user operating in a remote domain, such as the CAB user associated with the CAB client 130 operating in the remote domain 135. Because the detected event involves a CAB user operating in a remote domain, at block 710 the CAB server further determines that event information needs to be exchanged with the remote domain and, in particular, with a remote CAB server, such as the remote CAB server 125, operating in the remote domain. Examples of detected events that may require associated event related information to be exchanged with a remote domain include a detected new CAB user event, a detected address book add event, a detected contact subscription event, etc.

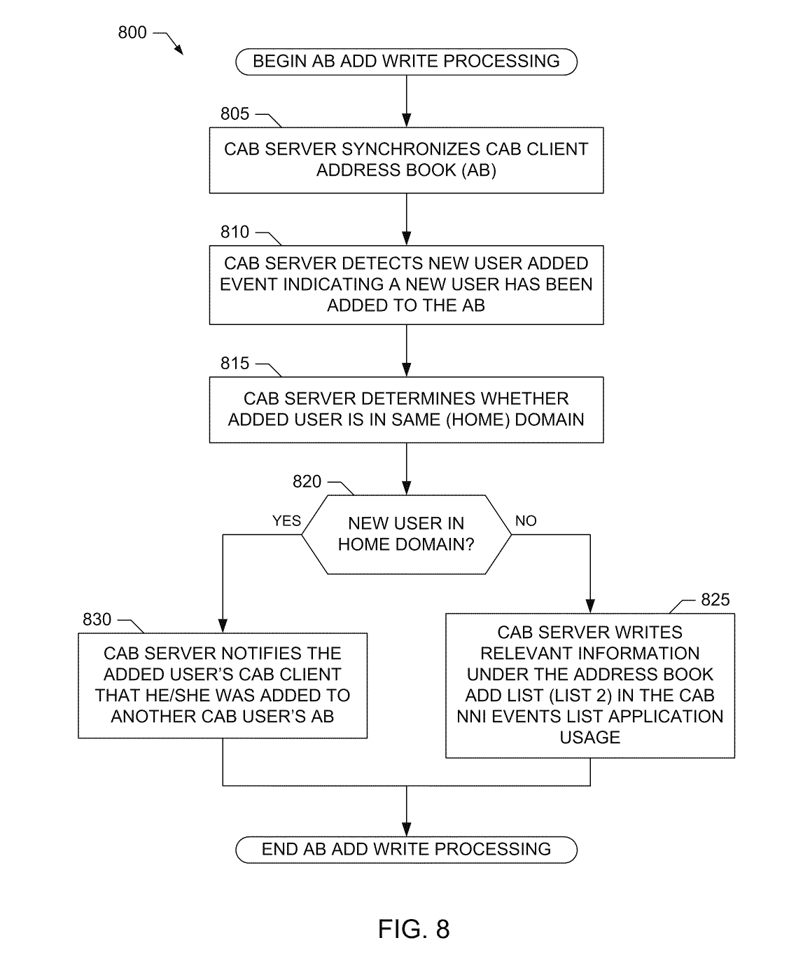

Next, at block 715 the NNI event writer 235 included in the CAB server 105 writes event information related to the detected event to a home CAB NNI events list maintained by the CAB server 105 in the CAB NNI events list XDMS 225. In an example implementation, the NNI event writer 235 writes the event information according to the CAB NNI events list application usage 500 illustrated in FIGS. 5A-D. Examples of write processing for detected address book add events, detected new CAB user events and detected contact subscription events are shown in FIGS. 8, 10 and 12, respectively, which are described in greater detail below.

Sometime later, at block 720 a remote CAB server, such as the remote CAB server 125, monitors, or watches, for the new event-related information written at block 715 to appear in the CAB NNI events list maintained by the CAB server 105. Because the processing at block 720 is performed by a CAB server that is different from the CAB server 105, block 720 is represented using a dashed line instead of a solid line. From the perspective of the CAB server 105, after processing at block 715 completes, the example process 700 ends.

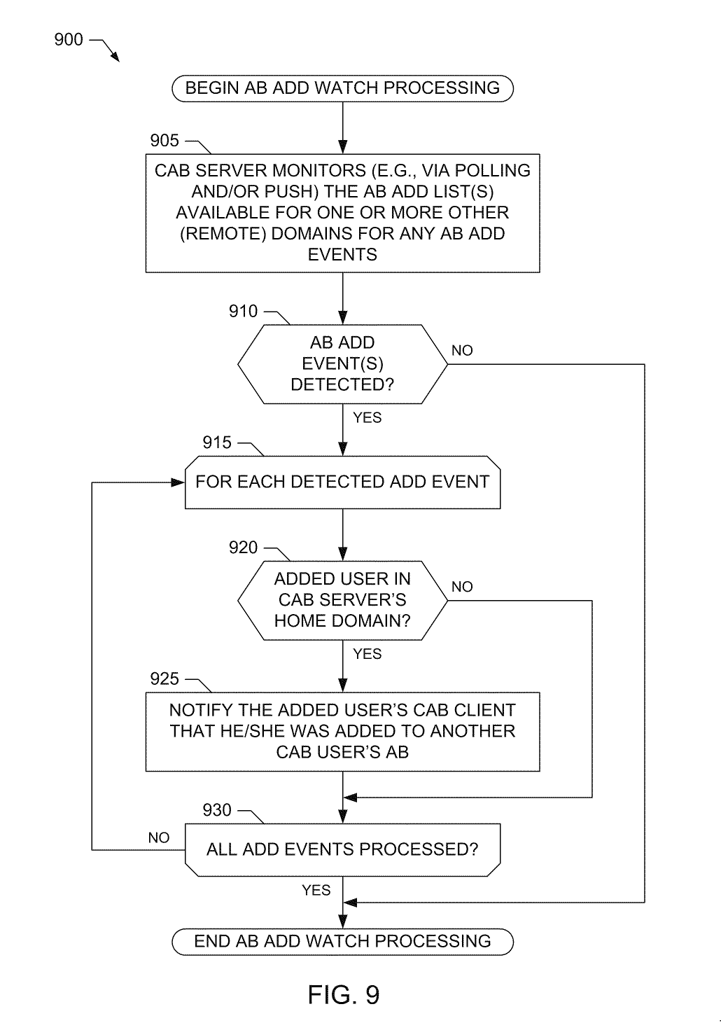

Turning to the process 705 of FIG. 7, this process begins at block 725 at which the NNI event watcher 240 included in the CAB server 105 monitors, or watches, for updates to the event-related information maintained by one or more remote CAB servers, such as the remote CAB server 125, in one or more remote CAB NNI events list stored in one or more remote CAB NNI events list XDMSs, such as the CAB NNI events list XDMS 325 of FIG. 3. When one or more event information updates are detected (block 730), operation proceeds to block 735. At block 735, the NNI event watcher 240 examines the updated event information to determine whether any of the associated events involve CAB users, such as the user associated with the CAB client 110, operating in its home domain 115. If so, the CAB server 105 processes the event information for these event(s) and provides the appropriate event notification(s) to the affected CAB clients in the home domain 115. Examples of watch processing of event information updates associated with address book add events, new CAB user events and contact subscription events are shown in FIGS. 9, 11 and 13, respectively, which are described in greater detail below. Then, after processing at block 735, the example process 705 ends.

An example process 800 that may be performed (e.g., executed) by the CAB server 105, the CAB server 125, or both, to write event information for detected address book (AB) add events in a CAB NNI events list is illustrated in FIG. 8. While the process 800 may be implemented by one or both of the CAB server 105 and the CAB server 125 in any or all of the CAB systems 100, 200 and 300, for brevity and clarity, operation of the process 800 is described from the perspective of implementation by the CAB server 105 in the CAB systems 100 and 200. Thus, with reference to FIGS. 1-2, and with reference to the CAB NNI events list application usage 500 illustrated in FIGS. 5A-D, the process 800 of FIG. 8 begins at block 805 at which the CAB server 105 synchronizes one or more address books maintained by one or more CAB clients, such as the CAB client 110, operating in the home domain 115.

Next, at block 810 the CAB server 105 detects an address book add event or, in other words, detects that a new user has been added to an address book that was synchronized at block 805. Then, at block 815 the CAB server 105 determines whether the added user detected at block 810 is a CAB user and is operating in the home domain 115 of the CAB server 105. If the added user is not in the home domain 115 (block 820) and, thus, is operating in a remote domain, such as the remote domain 135, operation proceeds to block 825.

At block 825, the NNI event writer 235 included in the CAB server 105 writes event information related to the address book add event detected at block 810 to a home CAB NNI events list maintained by the CAB server 105 in the CAB NNI events list XDMS 225. In an example implementation, the NNI event writer 235 writes the address book add event information according to the CAB NNI events list application usage 500 illustrated in FIGS. 5A-D. For example, at block 825 the NNI event writer 235 accesses the home CAB NNI events list maintained by the CAB server 105 and writes a new add event element 520 representing the new address book add event under the address book add list element 518. Contained in the new add event element 520, the NNI event writer 235 further writes an adding user info element 522 with a URI element 524 and optionally a PCC link element 526 for the adding CAB user, such as the CAB user associated with the CAB client 110, whose address book was updated to included the added user detected at block 810. Also contained in the new add event element 520, the NNI event writer 235 further writes an added user info element 528 with a URI element 530 for the added user operating in the remote domains, such as the CAB user associated with the CAB client 130 operating in the remote domain 135. After the write processing completes at block 825, the example process 800 ends.

Returning to block 820, if the added user is in the home domain 115, operation proceeds to block 830. At block 830, the CAB server 105 notifies the added user operating in the home domain 115 that he/she has been added to the address book of another CAB user, such as the CAB user associated with the CAB client 110, operating in the home domain 115. The example process 800 then ends.

An example process 900 that may be performed (e.g., executed) by the CAB server 105, the CAB server 125, or both, to monitor, or watch, for event information updates associated with address book (AB) add events in a remote CAB NNI events list is illustrated in FIG. 9. While the process 900 may be implemented by one or both of the CAB server 105 and the CAB server 125 in any or all of the CAB systems 100, 200 and 300, for brevity and clarity, operation of the process 900 is described from the perspective of implementation by the CAB server 105 in the CAB systems 100 and 200. Thus, with reference to FIGS. 1-2, and with reference to the CAB NNI events list application usage 500 illustrated in FIGS. 5A-D, the process 900 of FIG. 9 begins at block 905 at which the NNI event watcher 240 included in the CAB server 105 monitors, or watches, one or more remote CAB NNI events lists maintained in one or more remote CAB NNI events list XDMSs (such as the CAB NNI events list XDMS 325 of FIG. 3) by one or more remote CAB servers (such as the remote CAB server 125) for any event information updates associated with address book add events. For example, at block 905 the NNI event watcher 240 may use any appropriate polling or push mechanism, or any combination thereof, to detect a new add event element 520 written to a remote CAB NNI events list maintained in the CAB NNI events list XDMS 325 by the CAB server 125 for the remote domain 135.

If no event information updates associated with address book add events are detected (block 910), the example process 900 ends. However, if an event information update associated with an address book add event is detected (block 910), operation proceeds to block 915 at which each detected address book add event is processed. For example, for a first new add event 520 detected at blocks 905-910, control proceeds to block 920 at which the CAB server 105 determines whether the added user info element 528 and associated URI 530 for the new add event 520 correspond to an added CAB user operating in the home domain 115 of the CAB server 105. If the added CAB user is in the home domain 195 (block 920), operation proceeds to block 925 at which the CAB server 105 notifies the added CAB user, such as the CAB user associated with the CAB client 110, that he/she has been added to another CAB user's address book, such as the address book of the CAB user associated with the remote CAB client 130.

After notification processing completes at block 930, or if the added CAB user is not operating in the home domain 115 (block 920), the CAB server 105 continues processing the next add event 520 that was detected at blocks 905-910 (block 930) After all detected add events 520 have been processed (block 930), the process 900 ends.

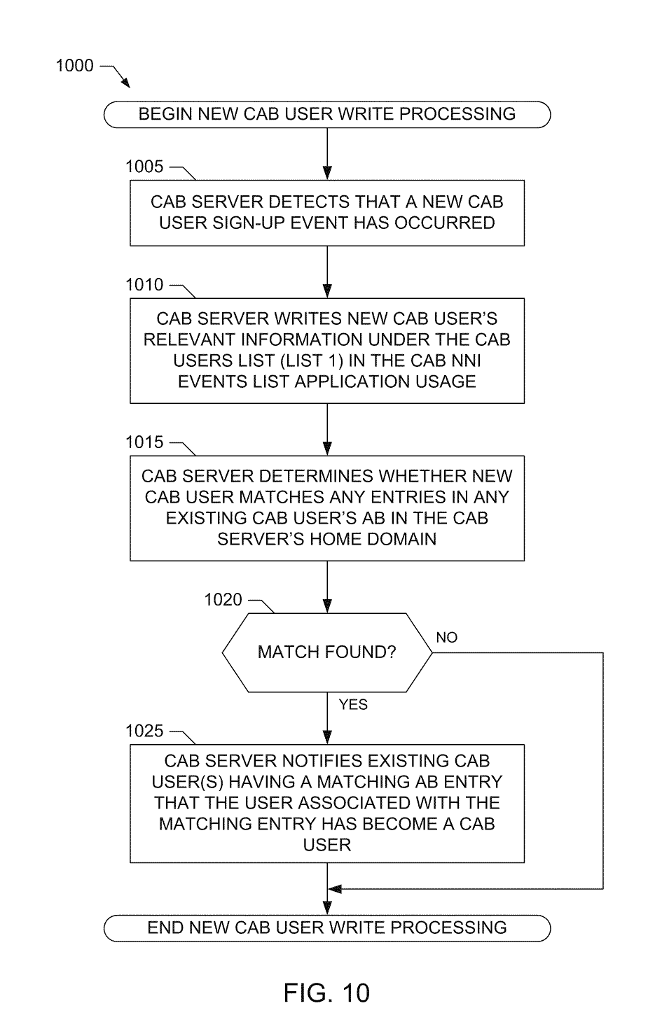

An example process 1000 that may be performed (e.g., executed) by the CAB server 105, the CAB server 125, or both, to write event information for detected new CAB user events in a CAB NNI events list is illustrated in FIG. 10. While the process 1000 may be implemented by one or both of the CAB server 105 and the CAB server 125 in any or all of the CAB systems 100, 200 and 300, for brevity and clarity, operation of the process 1000 is described from the perspective of implementation by the CAB server 105 in the CAB systems 100 and 200. Thus, with reference to FIGS. 1-2, and with reference to the CAB NNI events list application usage 500 illustrated in FIGS. 5A-D, the process 1000 of FIG. 10 begins at block 1005 at which the CAB server 105 detects that a new CAB user has signed up for CAB service provided by the CAB server 105.

Next, operation proceeds to block 1010 at which the NNI event writer 235 included in the CAB server 105 writes event information related to the new CAB user event detected at block 1005 to a home CAB NNI events list maintained by the CAB server 105 in the CAB NNI events list XDMS 225. In an example implementation, the NNI event writer 235 writes the new CAB user event information according to the CAB NNI events list application usage 500 illustrated in FIGS. 5A-D. For example, at block 1010 the NNI event writer 235 accesses the home CAB NNI events list maintained by the CAB server 105 and writes a new user identifier element 508 representing the new CAB user event under the CAB users list element 506. Contained in the new user identifier element 508, the NNI event writer 235 further writes a display name element 510, a URI element 512 and optionally a PCC link element 514 for the new CAB user detected at block 1005.

After write processing completes at block 1010, operation proceeds to block 1015 at which the CAB server 105 determines whether the new CAB user matches any entries in any address book maintained for an existing CAB user, such as the CAB user associated with the CAB client 110, operating in the home domain 115. If a match is not found (block 1020), the process 1000 ends. However, if a match is found (block 1020), operation proceeds to block 1025 at which the CAB server 105 notifies (e.g., using any conventional or unconventional technique) each existing CAB user having a matching address book entry that the user associated with the matching address book entry has become a CAB user. The process 1000 then ends.

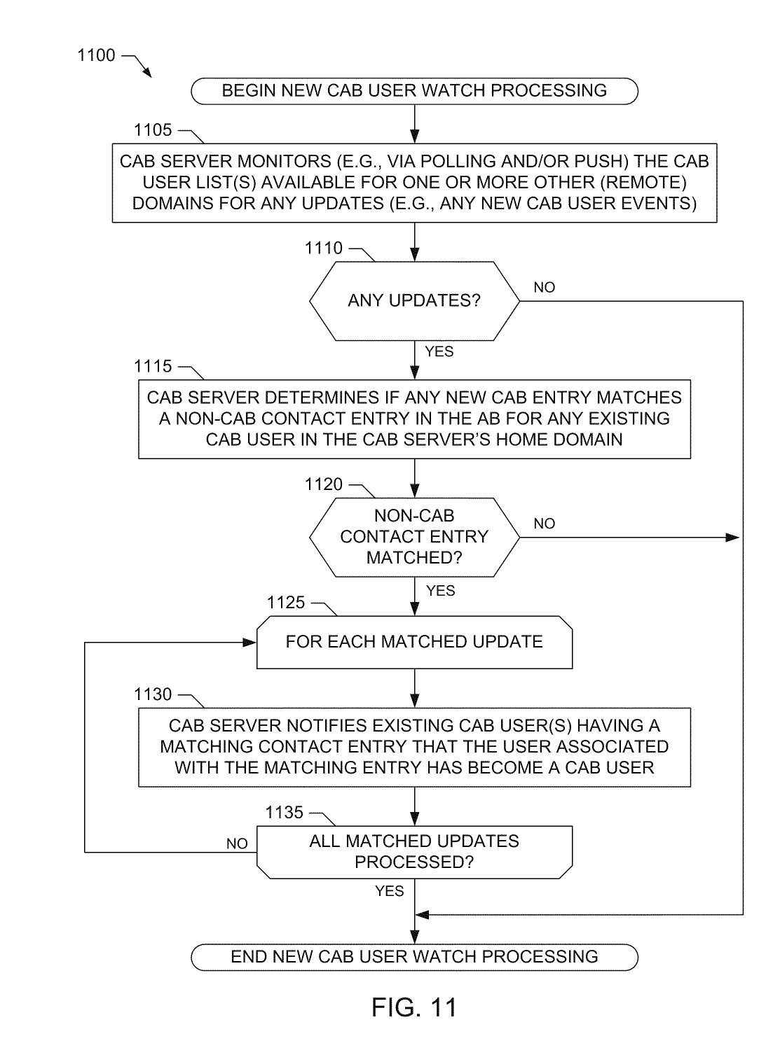

An example process 1100 that may be performed (e.g., executed) by the CAB server 105, the CAB server 125, or both, to monitor, or watch, for event information updates associated with new CAB user events in a remote CAB NNI events list is illustrated in FIG. 11. While the process 1100 may be implemented by one or both of the CAB server 105 and the CAB server 125 in any or all of the CAB systems 100, 200 and 300, for brevity and clarity, operation of the process 1100 is described from the perspective of implementation by the CAB server 105 in the CAB systems 100 and 200. Thus, with reference to FIGS. 1-2, and with reference to the CAB NNI events list application usage 500 illustrated in FIGS. 5A-D, the process 1100 of FIG. 11 begins at block 1105 at which the NNI event watcher 240 included in the CAB server 105 monitors, or watches, one or more remote CAB NNI events lists maintained in one or more remote CAB NNI events list XDMSs (such as the CAB NNI events list XDMS 325 of FIG. 3) by one or more remote CAB servers (such as the remote CAB server 125) for any event information updates associated with new CAB user events. For example, at block 1105 the NNI event watcher 240 may use any appropriate polling or push mechanism, or any combination thereof, to detect a new user identifier element 508 written to a remote CAB NNI events lists maintained in the CAB NNI events list XDMS 325 by the CAB server 125 for the remote domain 135.

If no event information updates associated with new CAB user events are detected (block 1110), the example process 1100 ends. However, if an event information updates associated with a new CAB user event is detected in a remote CAB server's CAB NNI events list (block 1110), operation proceeds to block 1115 at which the CAB server 105 determines whether any new user identifier element 508 detected at block 1105 matches any entry in any address book maintained for an existing CAB user, such as the CAB user associated with the CAB client 110, operating in the home domain 115. If a match is not found (block 1120), the process 1100 ends. However, if a match is found (block 1120), operation proceeds to block 1125 at which each new CAB user matching an address book entry for an existing CAB user in the home domain 115 is processed. For example, for a first matching new CAB user determined blocks 1115-1120, operation proceeds to block 1130 at which the CAB server 105 notifies each existing CAB user having a matching address book entry that the user associated with the matching address book entry has become a CAB user. The CAB server 105 then continues processing the next matching new CAB user determined at blocks 1115-1120 (block 1135) After all matching new CAB users have been processed (block 1135), the process 1100 ends.

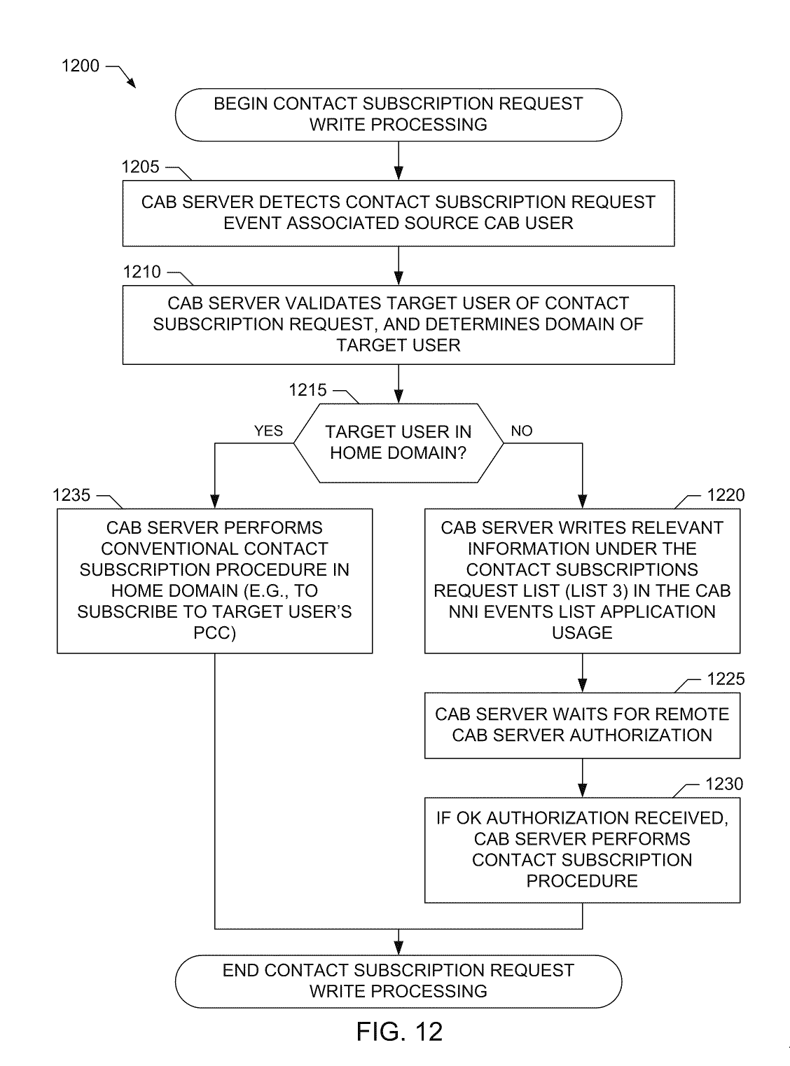

An example process 1200 that may be performed (e.g., executed) by the CAB server 105, the CAB server 125, or both, to write event information for detected contact subscription request events in a CAB NNI events list is illustrated in FIG. 12. While the process 1200 may be implemented by one or both of the CAB server 105 and the CAB server 125 in any or all of the CAB systems 100, 200 and 300, for brevity and clarity, operation of the process 1200 is described from the perspective of implementation by the CAB server 105 in the CAB systems 100 and 200. Thus, with reference to FIGS. 1-2, and with reference to the CAB NNI events list application usage 500 illustrated in FIGS. 5A-D, the process 1200 of FIG. 12 begins at block 1205 at which the CAB server 105 detects that a source CAB user, such as the CAB user associated with the CAB client 110, has made a contract subscription request.

Next, operation proceeds to block 1210 at which the CAB server 105 validates the target CAB user of the contact subscription request detected at block 1205. At block 1210, the CAB server 105 also determines the domain of the target CAB user. For example, the target CAB user may be the CAB user associated with the remote CAB client 130 and, thus, the domain of the target CAB user may be the remote domain 135. If the target user of the contact subscription request is not in the home domain 115 (block 1215) and, thus, is operating in a remote domain (such as the remote domain 135), operation proceeds to block 1220.

At block 1220, the NNI event writer 235 included in the CAB server 105 writes event information related to the contact subscription request event detected at block 1205 to a home CAB NNI events list maintained by the CAB server 105 in the CAB NNI events list XDMS 225. In an example implementation, the NNI event writer 235 writes the contact subscription request event information according to the CAB NNI events list application usage 500 illustrated in FIGS. 5A-D. For example, at block 1220 the NNI event writer 235 accesses the home CAB NNI events list maintained by the CAB server 105 and writes a new contact subscription element 538 representing the new contact subscription request event under the contact subscription requests list element 536. Contained in the new contact subscription element 538, the NNI event writer 235 further writes a display name element 540 and a URI element 542 representing the target CAB user to which the subscription request is being made. Also contained in the new contact subscription element 538, the NNI event writer 235 further writes an optional PCC link element 544 representing the source CAB user that made the contact subscription request. Additionally, the NNI event writer 235 writes an authorization state element having an initial value of ‘FALSE’ to represent the status of the contact subscription request.

After the write processing completes at block 1220, operation proceeds to block 1225 at which the CAB server 105 waits for the remote CAB server serving the target CAB user to update the authorization state element 546 for the contact subscription request. For example, if the target CAB user is the CAB user associated with the remote CAB client 130 operating in the remote domain 135, then at block 1225 the CAB server 105 waits for the remote CAB server 125 to update the authorization state element 546 for the contact subscription request. After the authorization state element 546 is updated by the remote CAB server at block 125, and if the authorization state is set to ‘OK,’ operation proceeds to block 1230 at which the CAB server 105 subscribes the source CAB user, such as the CAB user associated with the CAB client 110, to the target CAB user, such as the CAB user associated with the CAB client 135. The process 1200 then ends.

Returning to block 1215, if the target user of the contact subscription request is in the home domain 115, operation proceeds to block 1235. At block 1235, the CAB server 105 performs any subscription technique in the home domain 115 to subscribe the source CAB user in the home domain 115 to the target CAB user also in the home domain 115. The process 1200 then ends.

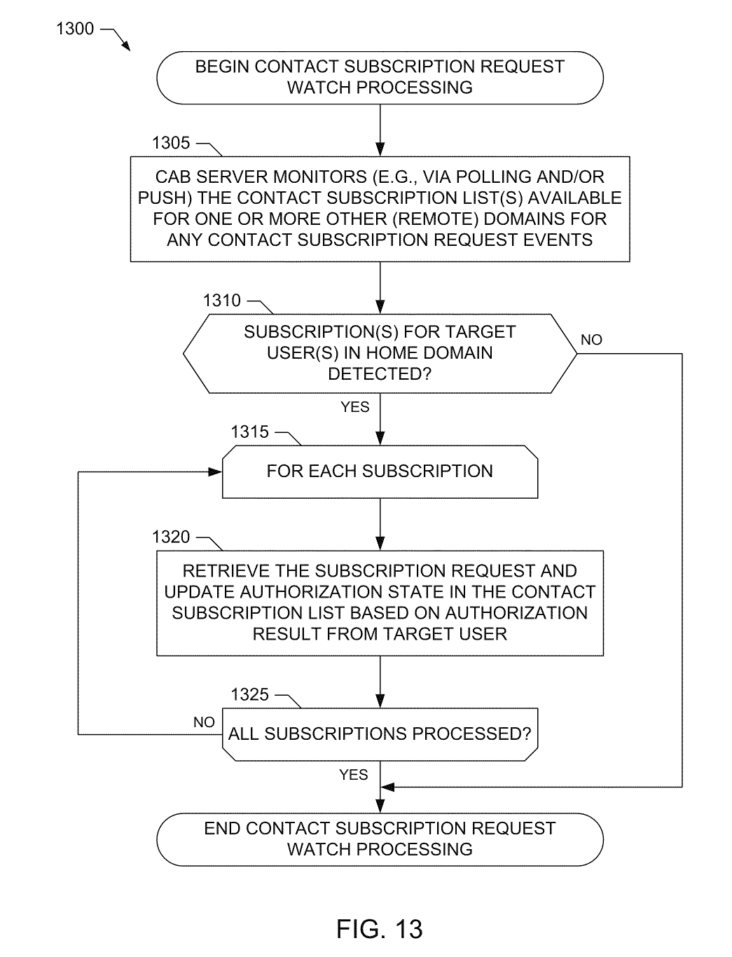

An example process 1300 that may be performed (e.g., executed) by the CAB server 105, the CAB server 125, or both, to monitor, or watch, for event information updates associated with contact subscription request events in a remote CAB NNI events list is illustrated in FIG. 13. While the process 1300 may be implemented by one or both of the CAB server 105 and the CAB server 125 in any or all of the CAB systems 100, 200 and 300, for brevity and clarity, operation of the process 1300 is described from the perspective of implementation by the CAB server 105 in the CAB systems 100 and 200. Thus, with reference to FIGS. 1-2, and with reference to the CAB NNI events list application usage 500 illustrated in FIGS. 5A-D, the process 1300 of FIG. 13 begins at block 1305 at which the NNI event watcher 240 included in the CAB server 105 monitors, or watches, one or more remote CAB NNI events lists maintained in one or more remote CAB NNI events list XDMSs (such as the CAB NNI events list XDMS 325 of FIG. 3) by one or more remote CAB servers (such as the remote CAB server 125) for any event information updates associated with contact subscription request events. For example, at block 1305 the NNI event watcher 240 may use any appropriate polling or push mechanism, or any combination thereof, to detect a new contact subscription element 538 written to a remote CAB NNI events list maintained in the CAB NNI events list XDMS 325 by the CAB server 125 for the remote domain 135.

If no event information updates associated with contact subscription request events having target CAB users in the home domain 115 are detected (block 1310), the example process 1300 ends. However, if an event information update associated with a contact subscription request having a target CAB user in the home domain 115 is detected (block 1310), operation proceeds to block 1315 at which each detected contact subscription request event having a target CAB user in the home domain 115 is processed.

For example, for a first contact subscription request event having a target CAB user operating in the home domain 115, operation proceeds to block 1320 at which the CAB server 105 retrieves the contact subscription request information from the remote CAB NNI events list and contacts the CAB client, such as the CAB client 110, associated with the target CAB user to obtain authorization for the contact subscription request. The CAB server 105 then updates the authorization state element 546 maintained for this contact subscription request based on the authorization received from the target CAB user. For example, the CAB server 105 sets the authorization state element 546 to ‘OK’ if the target CAB user authorizes the contact subscription request, and the CAB server 105 sets the authorization state element 546 to ‘REJECT’ otherwise.

After contact subscription authorization processing completes at block 1320, the CAB server 105 continues processing the next contact subscription request having a target user in the home domain 115 as detected at blocks 1305-1310 (block 1325) After all contact subscription request events have been processed (block 1325), the process 1300 ends.

FIG. 14 is a block diagram of an example processing system 1400 capable of implementing the apparatus and methods disclosed herein. The processing system 1400 can correspond to, for example, a mobile station processing platform, a network element processing platform, a server, a personal computer, a personal digital assistant (PDA), an Internet appliance, a mobile phone, or any other type of computing device.

The system 1400 of the instant example includes a processor 1412 such as a general purpose programmable processor, an embedded processor, a microcontroller, etc. The processor 1412 includes a local memory 1414, and executes coded instructions 1416 present in the local memory 1414 and/or in another memory device. The processor 1412 may execute, among other things, machine readable instructions to implement any, some or all of the processes represented in FIGS. 7-13. The processor 1412 may be any type of processing unit, such as one or more microprocessors from the Intel® Centrino® family of microprocessors, the Intel® Pentium® family of microprocessors, the Intel® Itanium® family of microprocessors, and/or the Intel® XScale® family of processors, one or more microcontrollers from the ARM® family of microcontrollers, the PIC® family of microcontrollers, etc. Of course, other processors from other families are also appropriate.

The processor 1412 is in communication with a main memory including a volatile memory 1418 and a non-volatile memory 1420 via a bus 1422. The volatile memory 1418 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1420 may be implemented by flash memory and/or any other desired type of memory device. Access to the main memory 1418, 1420 is typically controlled by a memory controller (not shown).

The system 1400 also includes an interface circuit 1424. The interface circuit 1424 may be implemented by any type of interface standard, such as an Ethernet interface, a universal serial bus (USB), and/or a third generation input/output (3GIO) interface.

One or more input devices 1426 are connected to the interface circuit 1424. The input device(s) 1426 permit a user to enter data and commands into the processor 1412. The input device(s) can be implemented by, for example, a keyboard, a mouse, a touchscreen, a track-pad, a trackball, an isopoint and/or a voice recognition system.

One or more output devices 1428 are also connected to the interface circuit 1424. The output devices 1428 can be implemented, for example, by display devices (e.g., a liquid crystal display, a cathode ray tube display (CRT)), by a printer and/or by speakers. The interface circuit 1424, thus, typically includes a graphics driver card.

The interface circuit 1424 also includes a communication device such as a modem or network interface card to facilitate exchange of data with external computers via a network (e.g., an Ethernet connection, a digital subscriber line (DSL), a telephone line, coaxial cable, a cellular telephone system such as an EGPRS-compliant system, etc.).

The system 1400 also includes one or more mass storage devices 1430 for storing software and data. Examples of such mass storage devices 1430 include floppy disk drives, hard drive disks, compact disk drives and digital versatile disk (DVD) drives. The mass storage device 1430 may store the CAB NNI events list(s) maintained by the CAB servers 105 or 125, or both. Additionally or alternatively, the volatile memory 1418 may store the CAB NNI events list(s) maintained by the CAB servers 105 or 125, or both.

As an alternative to implementing the methods and/or apparatus described herein in a system such as shown in FIG. 14, the methods and or apparatus described herein may be embedded in a structure such as a processor and/or an ASIC (application specific integrated circuit).

Finally, although certain example methods, apparatus and articles of manufacture have been described herein, the scope of coverage of the appended claims is not limited thereto. On the contrary, this disclosure covers all methods, apparatus and articles of manufacture fairly falling within the scope of the appended claims either literally or under the doctrine of equivalents.

What is claimed is:

1. A method for a converged address book (CAB) server, the method comprising:
detecting that a contact corresponding to a second CAB user has been added to an address book of a first CAB user, the address book being managed by the CAB server; and
exchanging data between a first domain associated with the first CAB user and a second domain associated with the second CAB user to provide a notification to the second CAB user when the contact corresponding to the second CAB user is added to the address book.

2. A method as defined in claim 1 wherein exchanging data comprises generating the data to be exchanged between the first domain and the second domain when the contact corresponding to the second CAB user is added to the address book.

3. A method as defined in claim 1 wherein exchanging data is performed via a network to network interface between the first domain and the second domain.

4. A method as defined in claim 1 wherein the data includes a first identifier representative of the first CAB user, and a second identifier representative of the second CAB user.

5. A method as defined in claim 4 wherein the first identifier comprises a first extensible markup language (XML) configuration access protocol (XCAP) user identifier (XUI), and the second identifier comprises a second XUI.

6. A method as defined in claim 1 further comprising determining, based on at least one of a preference or a policy, whether to exchange the data.

7. A method as defined in claim 1 wherein exchanging data comprises sending a session initiation protocol (SIP) message to a second CAB server associated with the second CAB user.

8. A tangible article of manufacture storing machine readable instructions which, when executed, cause a machine to implement the method defined in claim 1.

9. An apparatus comprising:
a processor to execute a converged address book (CAB) server configured to:
detect that a contact corresponding to a second CAB user has been added to an address book of a first CAB user, the address book being managed by the CAB server; and
generate data to be exchanged between a first domain associated with the first CAB user and a second domain associated with the second CAB user to provide a notification to the second CAB user when the contact corresponding to the second CAB user is added to the address book; and
a communication interface to send the data to be exchanged.

10. An apparatus as defined in claim 9 wherein the data includes a first identifier representative of the first CAB user, and a second identifier representative of the second CAB user.

11. An apparatus as defined in claim 10 wherein the first identifier comprises a first extensible markup language (XML) configuration access protocol (XCAP) user identifier (XUI), and the second identifier comprises a second XUI.

12. An apparatus as defined in claim 9 wherein the CAB server is further configured to determine, based on at least one of a preference or a policy, whether to exchange the data.

13. A method for a converged address book (CAB) server, the method comprising:
receiving data at a first CAB server of a first domain, the data being from a second CAB server of a second domain and indicating that a contact corresponding to a first CAB user of the first domain has been added to an address book associated with a second CAB user of the second domain; and
sending a notification to the first CAB user based on the received data.

14. A method as defined in claim 13 further comprising processing the received data to determine that the first CAB user has been added to the address book of the second CAB user.

15. A method as defined in claim 13 wherein receiving data is performed via a network to network interface between the first domain and the second domain.

16. A method as defined in claim 13 wherein the data includes a first identifier representative of the first CAB user, and a second identifier representative of the second CAB user.

17. A method as defined in claim 16 wherein the first identifier comprises a first extensible markup language (XML) configuration access protocol (XCAP) user identifier (XUI), and the second identifier comprises a second XUI.

18. A method as defined in claim 13 wherein the data is generated by the second CAB server when the contact corresponding to the first CAB user is added to the address book.

19. A method as defined in claim 13 wherein the notification is sent by updating a contact status field associated with the first CAB user.

20. A tangible article of manufacture storing machine readable instructions which, when executed, cause a machine to implement the method defined in claim 13.

21. An apparatus comprising:
a processor to execute a converged address book (CAB) server configured to receive data at a first CAB server of a first domain, the data being from a second CAB server of a second domain and indicating that a contact corresponding to a first CAB user of the first domain has been added to an address book associated with a second CAB user of the second domain; and
a communication interface to send a notification to the first CAB user based on the received data.

22. An apparatus as defined in claim 21 wherein processor is further configured to process the received data to determine that the first CAB user has been added to the address book of the second CAB user.

23. An apparatus as defined in claim 21 wherein the data includes a first identifier representative of the first CAB user, and a second identifier representative of the second CAB user.

24. An apparatus as defined in claim 23 wherein the first identifier comprises a first extensible markup language (XML) configuration access protocol (XCAP) user identifier (XUI), and the second identifier comprises a second XUI.

25. An apparatus as defined in claim 21 wherein the data is generated by the second CAB server when the contact corresponding to the first CAB user is added to the address book.

26. An apparatus as defined in claim 21 wherein the communication interface is to update a contact status field associated with the first CAB user to send the notification.
